(19) United States
(12) Patent Application Publication
(10) Pub. No.: US 2017/0193606 A1
(43) Pub. Date: Jul. 6, 2017

(54) Integrated Payment, Insurance, and Loyalty Platform Apparatuses, Methods, and Systems

(71) Applicant: Capgemini America, Inc., New York, NY (US)

(72) Inventors: Joe Thomas, Paris (FR); Ian Campos, Charlotte, NC (US)

(21) Appl. No.: 15/397,630

(22) Filed: Jan. 3, 2017

Related U.S. Application Data
(60) Provisional application No. 62/273,788, filed on Dec. 31, 2015.

(51) Int. Cl. G06Q 40/08; G06Q 20/24; G06Q 20/26; G06Q 30/02; G06Q 20/34

(52) U.S. Cl. CPC G06Q 40/08; G06Q 30/0226; G06Q 20/342; G06Q 20/26; G06Q 20/24; G06Q 50/01

(57) ABSTRACT

A system for integrating payment, insurance, and loyalty program services into a single platform is disclosed. The system includes a plurality of processors interfacing with a plurality of memory units; a channels module configured to run on one or more processors and to interface with a plurality of customer devices through a network; an interaction management module configured to run on the one or more processors and interface with the channels module to provide insurance products and services from an insurance provider to customers using the plurality of customer devices; a consumer management module configured to run on the processor and interface with the channels module and interaction management module, wherein the consumer management module includes a loyalty card functionality configured to store value for a customer and apply that value to interactions with the insurance provider through an application running on the customer device.

### CROSS REFERENCE TO RELATED APPLICATION

This application claims priority under 35 U.S.C. §119 to U.S. Provisional Patent Application No. 62/273,788, filed Dec. 31, 2015, the contents of which are incorporated by reference herein in their entirety.

### FIELD

This disclosure is directed generally to mobile systems for accessing content and services. More particularly, this disclosure is directed to INTEGRATED PAYMENT, INSURANCE, AND LOYALTY PLATFORM APPARATUSES, METHODS, AND SYSTEMS (hereinafter All-Insurance Platform).

### BACKGROUND

Nearly every transaction involving insurance that consumers are faced with is laden with frustration and friction. Consumers typically interact with many disparate and disconnected distribution channels and companies to buy different types of insurance policies and services. Consumers also typically need to interact through different communication channels, including inefficient paper forms, to carry out insurance-related processes like buying a policy, submitting a claim, and paying premiums. These disparate communication and distribution channels cause consumer frustration, and the inefficiencies associated with these distribution channels cost insurance companies money.

### BRIEF DESCRIPTION OF THE DRAWINGS

The accompanying drawings illustrate various non-limiting, exemplary, inventive aspects of the All-Insurance Platform:

FIG. 1 is a systems architecture diagram illustrating an exemplary embodiment of the All-Insurance Platform;

FIG. 2 is a systems architecture diagram illustrating omni-channel integration facilities in an exemplary embodiment of the All-Insurance Platform;

FIG. 3 illustrates an exemplary embodiment of how the All-Insurance Platform can be configured to assist in a new-customer acquisition scenario;

FIG. 4 illustrates an exemplary embodiment of how the All-Insurance Platform can be configured to assist a customer with payment for products and services using loyalty points as well as adding additional card holders to an account;

FIG. 5 illustrates an exemplary embodiment of how the All-Insurance Platform can be configured to assist in cross-selling and updating insurance policies for customers;

FIG. 6 illustrates an exemplary embodiment of how the All-Insurance Platform can be configured to execute efficient claims handling in emergency scenarios;

FIG. 7 illustrates an exemplary embodiment of how the All-Insurance Platform can be configured to identify opportunities for sales and assist in closing those sales;

FIG. 8 illustrates an exemplary embodiment of how the All-Insurance Platform can be configured to assist in customer conversion and retention;

FIG. 9 is a mobile integrated architecture framework used in an exemplary embodiment of the All-Insurance Platform;

FIG. 10 is a systems architecture diagram showing an exemplary embodiment of a customer mobile architecture for use in the All-Insurance Platform;

FIG. 11 illustrates a use case for a login procedure for a mobile app in one embodiment of the All-Insurance Platform;

FIG. 12 illustrates exemplary screenshots of what a user might encounter when logging in to a mobile app in one embodiment of the All-Insurance Platform;

FIG. 13 illustrates a use case showing how a user might navigate through the menu in the mobile app to access a car insurance section of the app and submit a claim in real time using an “emergency” button in one embodiment of the All-Insurance Platform;

FIG. 14 illustrates exemplary screenshots and functionality corresponding to the use case shown in FIG. 13;

FIG. 15 illustrates a use case showing how a user might navigate through the menu of the mobile app to access life insurance products, run simulations, and get a quote and an insurance proposal using the mobile app in one embodiment of the All-Insurance Platform;

FIG. 16 illustrates exemplary screenshots and functionality corresponding to the use case shown in FIG. 15;

FIG. 17 illustrates a use case for the insurance-provider-branded loyalty card functionality that may be integrated into the mobile app in one embodiment of the All-Insurance Platform;

FIG. 18 illustrates exemplary screenshots showing the transaction functionality, which may include access to transaction details and transaction history for an insurance-provider-branded card in one embodiment of the All-Insurance Platform;

FIG. 19 illustrates exemplary screenshots showing the offers functionality of the “my card” section of the mobile app in one embodiment of the All-Insurance Platform;

FIG. 20 illustrates exemplary screenshots showing the rewards functionality of the “my card” section of the mobile app in one embodiment of the All-Insurance Platform;

FIG. 21 illustrates exemplary screenshots showing the dashboard functionality of the “my card” section of the mobile app in one embodiment of the All-Insurance Platform;

FIG. 22 is illustrates an exemplary use case where a user of the mobile app is accessing a contact function of the mobile app in one embodiment of the All-Insurance Platform;

FIG. 23 illustrates exemplary screenshots that the user might encounter when accessing the contacts function of the mobile app in one embodiment of the All-Insurance Platform;

FIG. 24 illustrates an exemplary use case where a user of the mobile app is accessing a document vault function in the mobile app in one embodiment of the All-Insurance Platform;

FIG. 25 illustrates exemplary screenshots that the user might encounter when accessing the document vault in one embodiment of the All-Insurance Platform;

FIG. 26 illustrates an exemplary use case where a user is able to access the knowledge center within the mobile app in one embodiment of the All-Insurance Platform;

FIG. 27 illustrates exemplary screenshots that the user may encounter when accessing the knowledge center within the mobile app in one embodiment of the All-Insurance Platform;

FIG. 28 illustrates an exemplary use case where a user accesses the timeline functionality from the menu of the mobile app in one embodiment of the All-Insurance Platform;

FIG. 29 illustrates exemplary screenshots of the timeline functionality of the mobile app in one embodiment of the All-Insurance Platform;

FIG. 30 illustrates an exemplary use case where a user accesses the payments functionality of the mobile app in one embodiment of the All-Insurance Platform;

FIG. 31 illustrates exemplary screenshots of that might be encountered by a user when accessing the payments functionality in one embodiment of the All-Insurance Platform;

FIG. 32 illustrates an exemplary use case where a user accesses the “plan a trip” functionality within the mobile app in one embodiment of the All-Insurance Platform;

FIG. 33 shows exemplary screenshots for the “plan a trip” functionality within the mobile app in one embodiment of the All-Insurance Platform;

FIG. 34 illustrates an exemplary use case where a user accesses “home security and monitoring” functionality of the mobile app in one embodiment of the All-Insurance Platform;

FIG. 35 illustrates exemplary screenshots of the “home security and monitoring” functionality of the mobile app in one embodiment of the All-Insurance Platform;

FIG. 36 illustrates an exemplary use case where a user accesses “home repair” functionality of the mobile app in one embodiment of the All-Insurance Platform;

FIG. 37 illustrates exemplary screenshots of the “home repair” functionality” of the mobile app in one embodiment of the All-Insurance Platform;

FIG. 38 illustrates an exemplary use case where a user accesses a “health and fitness” functionality from within the mobile app in one embodiment of the All-Insurance Platform;

FIG. 39 illustrates exemplary screenshots of a “health and fitness” functionality within the mobile app in one embodiment of the All-Insurance Platform;

FIG. 40 illustrates an exemplary dashboard within a user interface in one exemplary embodiment of the All-Insurance Platform; and

FIG. 41 is a block diagram illustrating embodiments of the All-Insurance Platform controller.

### SUMMARY

A system for integrating payment, insurance, and loyalty program services into a single platform is disclosed. The system includes a plurality of processors interfacing with a plurality of memory units; a channels module configured to run on one or more processors and to interface with a plurality of customer devices through a network; an interaction management module configured to run on the one or more processors and interface with the channels module to provide insurance products and services from an insurance provider to customers using the plurality of customer devices; a consumer management module configured to run on the processor and interface with the channels module and interaction management module, wherein the consumer management module includes a loyalty card functionality configured to store value for a customer and apply that value to interactions with the insurance provider through an application running on the customer device.

A method for integrating payment, insurance, and loyalty program services into a single platform is also disclosed. The method includes providing a channels module configured to run on one or more processors and to interface with a channels module configured to run on one or more processors and to interface with a plurality of customer devices through a network; providing an interaction management module configured to run on the one or more processors and interface with the channels module to provide insurance products and services from an insurance provider to customers using the plurality of customer devices; providing a consumer management module configured to run on the processor and interface with the channels module and interaction management module; and providing loyalty card functionality within the consumer management module, the loyalty card functionality being configured to store value for a customer and apply that value to interactions with the insurance provider through an application running on the customer device.

### DETAILED DESCRIPTION

This disclosure describes INTEGRATED PAYMENT, INSURANCE, AND LOYALTY PLATFORM APPARATUSES, METHODS, AND SYSTEMS (All-Insurance Platform), which is an innovative solution that gives customers applications with functionality to easily get quotes for, as well as purchase insurance products across life and non-life product lines. In addition, the All-Insurance Platform can be configured to provide an overview of all active policies, execute and receive payments using an integrated credit card, debit card, or stored-value card, and provide electronic claim notification and handling with automatic data pre-filling and photo capturing, among other features.

Using the All-Insurance Platform, an insurance company can offer tailored, rebated insurance products based on data captured through its customers' use of mobile and other applications that are part of the All-Insurance Platform. An insurance company using the All-Insurance Platform will also be able to automate processes to increase efficiency. The All-Insurance Platform may be configured to provide consumers with a single view of all activity related to all types of insurance and insurance-related products and services. For example, the All-Insurance Platform may include a mobile application that provides access to all insurance-related products and services, including an integrated loyalty credit card, debit card, or stored-value card for mobile payments.

In one exemplary embodiment, the All-Insurance Platform offers a mobile application configured to allow a consumer to: get quotes for and buy insurance products across life and non-life product lines online; access an overview of all active policies and risk coverage; show open and executed payments and execute payments using an integrated credit card; collect loyalty points for payments using the credit card and in turn use the loyalty points for insurance premium payments; receive electronic claim notification and handling with automatic data pre-filling, location data, and photo capturing; and handle claim payments with the credit card so that the customer does not need to pre-finance claim costs.

In one embodiment, an insurance company can use the All-Insurance Platform to offer tailored insurance products based on captured detailed customer data and use this data for more precise risk calculation and pricing. The All-Insurance Platform may be used to collect, aggregate, and analyze the data, and the data may be used to identify cross-selling opportunities with special rebates offered to customers on relevant insurance products.

The All-Insurance Platform may also provide a mobile solution integrated with a cloud-services platform that in turn integrates with core insurance systems and enables higher degrees of automated processes like business-rule-based, straight-through processing of quotes, issuing of policies, and claims processing.

In one exemplary embodiment, the All-Insurance Platform has the following technical components: mobile applications with versions for multiple devices (smart phones, tablets, laptops, desktops, and any other suitable device); a cloud-services orchestration platform based all-channel integration; cloud-based customer relationship management (CRM) functionality; integration middleware; and electronic content management, document production, e-signature, data management, and analytics capabilities.

By providing customers with a single view for all insurance related products and services, the All-Insurance Platform can be a powerful tool for both consumers and insurance providers. For consumers, it provides the convenience of one-stop shopping and access to a wealth of information. For insurance companies and other businesses, it also provides a wealth of information that can be used to increase customer loyalty and cross-selling opportunities. For example, using the All-Insurance Platform, an insurer could partner with a network of third-party businesses to provide its customers with special offers tailored to individual customers. These offers could be relevant to reducing risk or repairing damages (related to a house, a car, or healthcare, for example), but could also be offered for other goods and services that the consumer is likely to want based on his or her profile information gathered by and stored in the All-Insurance Platform.

In one embodiment, the All-Insurance Platform may provide customers of an insurance company with a single interaction point for all their insurance needs. The All-Insurance Platform may offer a customer-centric and ‘outside-in’ perspective for insurers and may fuel growth by capturing market share from more traditional insurers. In one embodiment, the All-Insurance Platform is focused on the following: digital interaction, mobile apps, policy holder vs. policy centricity, social-media listening, cross-product/cross-platform integration, and ease of doing business with insurance companies.

In one embodiment, the All-Insurance Platform enables customers of an insurance company to access the entire portfolio of their insurance needs through a single interface. This can be accomplished in many ways, including through a “direct” mode and via digital enablement of agents. In one embodiment, the All-Insurance Platform may also include a “single premium” functionality covering both life and non-life insurance needs. In one embodiment, the All-Insurance Platform may use social media to follow key events in a current or potential customer's life, and includes the positioning of specific online advertisements which target insurance needs that are most relevant to that customer, such as advertisements relating to an upcoming marriage or to the birth of a child.

The All-Insurance Platform may include a mobile app, an electronic card, social media interfaces, and a plurality of scenarios covering a customer's life and non-life insurance needs. The mobile app may be configured for use on any number of smart phones and tablets, including those running Apple, Android, and Windows operating systems. The All-Insurance Platform may also include a debit card and a stored-value card, which could be used for claims payment as well as for emergency “cash.” The All-Insurance Platform may also include an insurance-company-branded credit or debit card configured to cover virtually every need of a policy holder need, including the ability to make automated premium payments that generate loyalty points.

In one exemplary embodiment, the All-Insurance Platform is built on a cloud-based platform that fully integrates with systems from any number of banks, credit-card companies, payment providers, and technology companies. Data gathered via the mobile app, e-cards, and physical stored-value and credit cards may be used to enhance customer propositions and increase policy-holder retention and “stickiness” through the creation of loyalty programs. By using the All-Insurance Platform, insurance companies may be able to increase their Net Promoter Score (NPS) as well as their brand value.

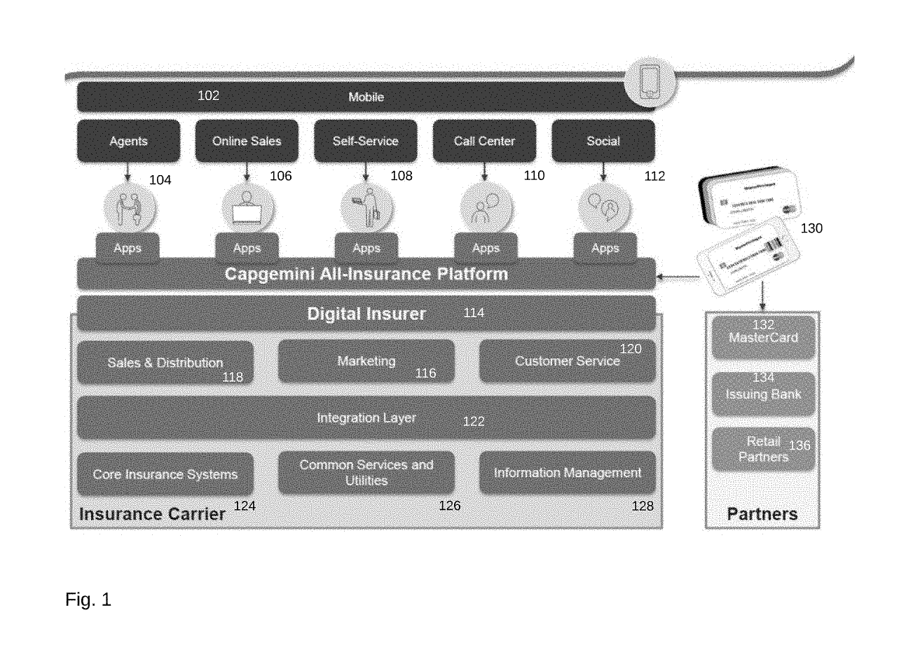

FIG. 1 is a systems architecture diagram illustrating an exemplary embodiment of the All-Insurance Platform. As shown, the All-Insurance Platform may integrate a plurality of mobile applications 102, including applications for use by agents, customers, customer-service representatives, and other users. For example, the All-Insurance Platform may include applications customized for use by insurance agents 104, online sales representatives 106, directly by customers in a self-service scenario 108, call center representatives 110, and for use with social media platforms 112. The All-Insurance Platform may be configured to interface with each of these mobile applications and connect the applications with a digital insurer interface 114.

Digital insurer interface 114 may be configured to provide access to marketing channels 116, sales and distribution channels 118, customer service channels 120, and other channels that may be useful in meeting the needs of the varied users accessing digital insurer interface 114 through mobile applications 102.

An integration layer 122 may also form a part of digital insurer interface 114 and may be configured to interface with, and provide access to, core insurance systems 124, common services and utilities 126, and information-management systems 128. The All-Insurance Platform may also be integrated with a customer loyalty credit card or debit card 130 issued to qualified insureds, who can then earn spending points that can be used to pay down insurance premiums, pay for repairs and restoration services, and buy goods at a discount, among other uses. The loyalty cards may also be configured to automatically add loyalty points or credits based on the driving record of the holder of the card.

In one exemplary embodiment, the All-Insurance Platform may be configured to interface with systems of a payment network provider 132, an issuing bank 134, and at one or more retail partners 136 to provide services and rewards programs in relation to the loyalty credit card 130. The All-Insurance Platform may also be configured to provide a stored-value card that is not tied to a bank or other financial institution, but that could also be used to pay down insurance premiums, pay for repairs, buy goods at a discount, and other uses related to the digital insurer or its partners.

Currently, many insurance companies still issue payments via checks and electronic fund transfers to bank accounts. In many cases, these payments can take between two and five days to be delivered and available for customers to use. In many situations, customers need access to these funds much more quickly—especially in emergency situations. The All-Insurance Platform addresses this need by providing loyalty credit cards as well as stored-value cards that may be directly connected to the insurance company as well as to other merchants that can provide services to customers in time of need.

For example, the All-Insurance Platform may include a prepaid card that can be used anywhere that debit cards are accepted. This prepared card may be configured such that it does not require a bank account or credit check before it is issued. The prepaid card may be used to support quick and safe delivery of emergency funds to customers on a nearly immediate basis. In one exemplary embodiment, cards may be recharged with additional fund as needed and spending can be controlled and tracked both by the customer and the insurance provider. In addition to a physical prepaid card, the All-Insurance Platform may also be configured to deliver funds to a mobile device, mobile wallet, or other application, combined with a prepaid card or virtual credit card number.

In one exemplary embodiment, the All-Insurance Platform is configured to integrate and interface with the systems of payment network providers (such as Visa and MasterCard), banks or other car issuers, and retail partners. The payment network providers allow the All-Insurance Platform to access payment processing technology and in return receive an increase in spend, since premiums and other payments would likely have otherwise been paid by check. A bank that issues the card and manages collections is able to access a pool of customers of the insurance provider and also gains in increased share of spend that it might not otherwise have access to. Retail partners may provide discounts to customers using the stored-value or credit cards and in return receive access to these customers. Partners could include repair networks, body shops, tire companies, hotel chains, and others willing to provide discounted services through to the customers of the insurance provider that use the cards.

In one exemplary embodiment, the All-Insurance Platform provides processing services to support sign-up of both customers and partners. The All-Insurance Platform may also be configured to collect affinity fees from card issuers and partners in return for access to the customer base of the insurance provider. Customers using the cards, which may include branding of the insurance provider, may also be eligible for discounts on premiums at the insurance provider as well as discounts on products and services from the retail partners. This gives a customer the opportunity to “earn back” what they spend on insurance premiums, which increases retention of customers for the insurance provider.

In addition to emergency use, these prepaid cards, credit cards, and mobile applications may be configured by the All-Insurance Platform for used for regular monthly payments (workman's compensation, liability, and other premiums, for example). Advantageously, this increases efficiency by eliminating paper-based check processing. The All-Insurance Platform may also be configured to use these types of systems for insurance carrier credit services claims processing.

In one exemplary embodiment, the All-Insurance Platform may be configured to interface with a payment system provider, card issuer, and retail partners to provide customers with a credit card that can be branded by the insurance provider and issued to qualifying customers. These customers can then earn spending points that can be used to pay down their premiums charged by the insurance provider. Additionally, these cards may be used for insurance-provider-approved repair and restoration services, for example after a car accident. The All-Insurance Platform may also be configured to provide statement credits for good driving records and other exemplary behavior, which incentivizes the customer to continue using the card and related services. This can result in additional revenue for the insurance provider as it becomes an issuer or an affinity partner of an issuer.

In one exemplary embodiment, the All-Insurance Platform may be configured to provide a single digital interaction point for all the insurance needs of a customer. This could include a mobile, desktop, and other applications that are integrated with a stored-value card or credit card and that allow a customer to access these cards through the mobile application to interact with an insurance carrier and other partners. The All-Insurance Platform may also include social media interaction capabilities that allow a customer to interact with the insurance provider through social media and which allow the insurance provider to provide tailored insurance offerings to the customer based on monitored social media feeds and activity.

The All-Insurance Platform may also integrate claims services into the mobile application, including automated claim handling applications with integrated video chat with claim adjusters, while also allowing a customer to make payments using the integrated prepaid card, debit card, or credit card. The mobile application may also include a document vault functionality that provides secure and easy access to policy details, travel documents, receipts, and other important documents. The mobile application integrated into the All-Insurance Platform can thus serve as a single interaction point for the customer, which is also beneficial to the insurance provider, since the provider can integrate sales, payment, analytics, social media listening, and other services into a single platform.

In one exemplary embodiment, the All-Insurance Platform is configured to take advantage of digital, mobility, data-driven, cloud and web-oriented architecture/technologies to enable a target operating model that is built on the core principles of: product and process innovation; data-driven underwriting and claims processing discipline; ability to comply with a myriad of regulatory needs across all geographies; and enabling speed-to-market.

The All-Insurance Platform may be designed to be customer-centric rather than policy-centric, taking a relationship and lifetime value view of a customer and aligning the entire operation around the customer rather than a policy. By contrast, current legacy systems are policy and line-of-business centric, which causes inefficiencies and hinders customer retention. The All-Insurance Platform may also be designed to focus on and enhance the experience of not only customers, but also employees and partners (agents/brokers, claims vendor network etc.).

The All-Insurance Platform may be configured to capture, augment, analyze, and incorporate data into day-to-day decision making, not just in strategic decision making situations. For example, the All-Insurance Platform may be configured to provide straight-through processing of simple claims, segmentation of complex claims, next-best offer in client-care situations, and detection of potentially fraudulent transactions.

In addition to providing a single-point of interaction from customers through mobile and other applications, the All-Insurance Platform may also be configured to integrate all channels and functions of an insurance provider or other organization in a single platform. This may include, for example, product definition; underwriting, rating and policy administration; marketing, sales and distribution; claims and information management and analytics; billing, document, financial, and regulatory compliance; and any other function that is necessary to run the insurance provider's business. These omni-channel integration facilities made possible by the All-Insurance Platform allow an insurance provider to implement an experience driven, effective, and efficient business model.

The omni-channel integration facilities of the All-Insurance Platform allow insurance providers to better understand their customers and develop the vision, proposition, business model, roadmap, and business case to deliver what its customers want and need. The All-Insurance Platform allows insurance providers to manage pricing across all channels and provide value for money to customers and intermediaries, which drives sales. The All-Insurance Platform may also allow an insurance provider to maintain a personal and relevant dialog with individual customers and markets across multiple communication and distribution channels, which allows the insurance provider to learn more about its customers and potential customers to improve conversion rates. By allowing a provider to effectively manage high-quality rich and inspiration content across multiple distribution channels, the All-Insurance Platform can provide higher customer engagement with the insurance provider and its intermediaries.

In one exemplary embodiment, the All-Insurance Platform may be configured to include a user interface with a dashboard where a user at an insurance provider can access a single view of data for all strategic, tactical, and operation decision making to improve accuracy, avoid duplication, and increase insight. This functionality may also allow the insurance provider to monitor and optimize the performance of its business across all channels and improve efficiency to effectively deliver underwriting, claims, fraud management, and investment services. The omni-channel integration of the All-Insurance Platform thus improves the customer experience and enables higher profitability for the insurance provider by enhancing growth and increasing customer loyalty.

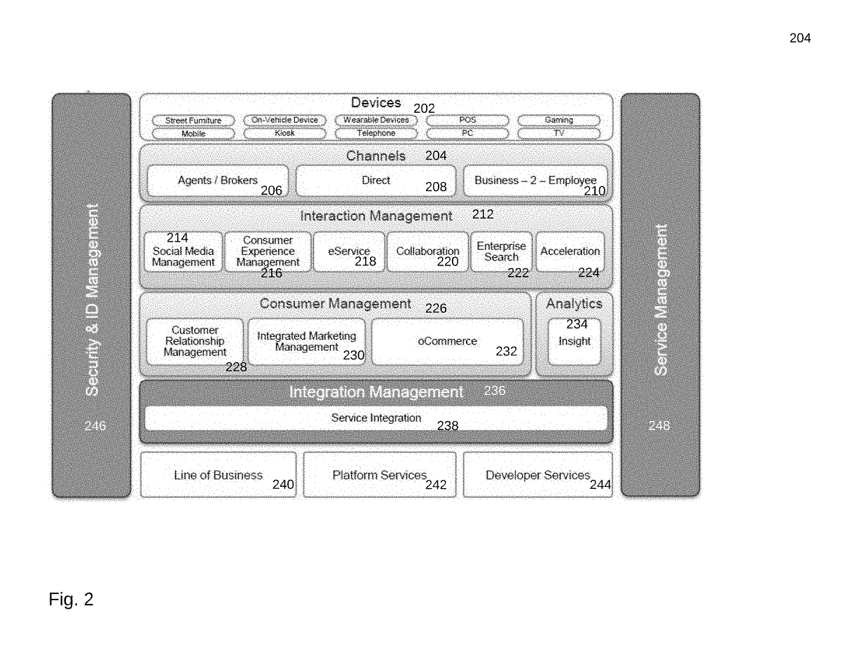

FIG. 2 is a systems architecture diagram illustrating omni-channel integration facilities in an exemplary embodiment of the All-Insurance Platform. As shown, the All-Insurance Platform may interface with any number of user devices 202, including mobile devices, on-vehicle devices, kiosks, wearable devices, point-of-sale devices, tablets, smartphones, desktops, smart television devices, gaming consoles, and any other suitable device that may be connected to a network to allow interaction with other components of the All-Insurance Platform.

User devices 202 may be configured to interface with a plurality of channels 204, which may include agent/broker channels 206, direct channels 208, business to employee channels 210, or any other suitable channel. These channels 204 may facilitate communication with customers, users, partners, and others using devices 202 through a plurality of interaction management modules 212. Interaction modules 212 may include social media management modules 214, consumer experience management modules 216, eService modules 218, collaboration modules 220, enterprise search modules 222, and acceleration modules 224.

The All-Insurance Platform may also in include a consumer management component 226, which may include customer relationship management modules 228, integrated marketing management modules 230, and electronic commerce modules 232. The All-Insurance Platform may also include an analytics engine 234, an integration management component 236 that includes service integration 238, a line-of-business component 240, a platform services component 242, a developer services component 244, a security and ID management component 246, and a service management component 248. In one exemplary embodiment of the All-Insurance Platform, each of these components is configured to interface with one another and with a payment, prepaid card, and credit card system to provide omni-channel functionality.

The omni-channel functionality of the All-Insurance Platform is needed because although insurance agents remain trusted advisors, newer digital channels like mobile and social are gaining significant ground. The All-Insurance Platform allows for the movement of both customer and product data from one channel to the other seamlessly, which gives customers the flexibility that they demand. The All-Insurance Platform can be configured to allow access to reference documents, pricing information, and servicing options and facilitates delivery of these assets at the right time. This gives organizations that use the All-Insurance Platform insights that allow these organization to develop the next level of products and services based on customer preferences, channels, and transactions, which in turn improves customer experience and loyalty.

The All-Insurance Platform is configured to achieve these objectives by integrating both customer-facing processes and operational processes. For example, customer-facing functionality integrated into the All-Insurance Platform may include a social media module that monitors a company's reputation, promotes products and services, sells products and services, provides customer service, and builds customer communities. Other customer-facing functionality may include customer experience modules and mobile channel modules. Operational processes and modules of the All-Insurance Platform may include analytics, process digitization internal collaboration, and data integration.

Analytics may be integrated with all other modules, components, and systems of the All-Insurance Platform to target marketing more effectively, personalize marketing, optimize pricing, and better qualify sales prospects. Process digitization may be used to automate processes, monitor operations in real time, and increase adaptability to external changes. Internal collaboration functionality of the All-Insurance Platform may facilitate active knowledge sharing, use of internal social networks and video conferencing capabilities, and remote working at any time from any device. The All-Insurance Platform may also include a data integration component that receives data from all other components of the All-Insurance Platform, including customer data and finance, supply-chain, and operations data, so that the data can be analyzed and used effectively.

By integrating the customer-facing processes and the operational processes, the All-Insurance Platform is able to extract meaningful information and use that information to better serve customers. Functionality made possible by this omni-channel approach includes social listening, gamification, cross-channel migration, electronic letterbox and filing, mobile document upload, social amplification, next-best-action analytics, remote diary management, telematics-enable claims triage, fraud analytics, accelerated claims settlement, and single-view functionality for a given customer. In one exemplary embodiment, the functionality of the All-Insurance Platform can be accessed through multiple devices and channels, including web, mobile, portal, email, SMS, call centers, and smartphones.

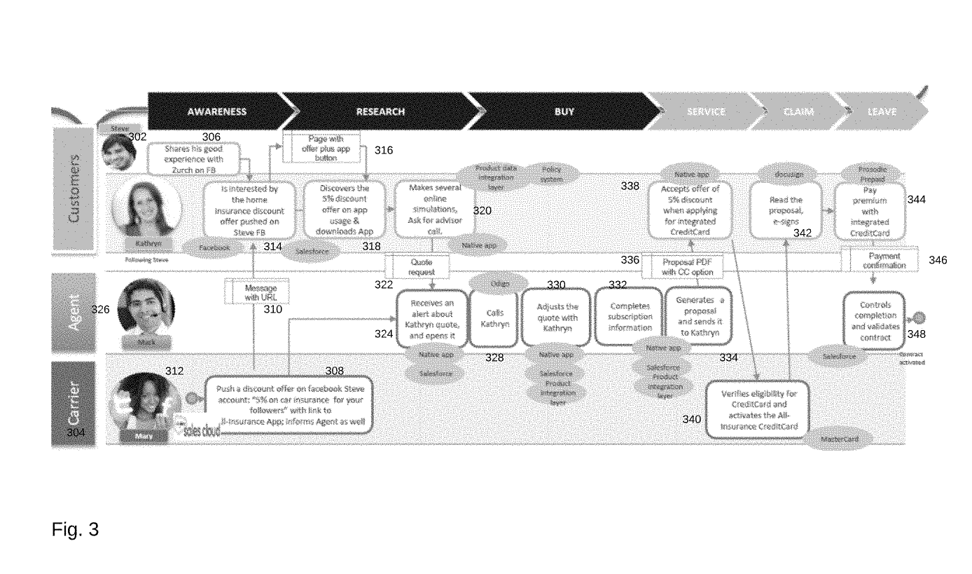

FIGS. 3 through 8 illustrate information flows for various uses of the All-Insurance Platform. FIG. 3 illustrates an exemplary embodiment of how the All-Insurance Platform can be configured to assist in a new-customer acquisition scenario. As shown in FIG. 2, the All-Insurance Platform may include a social media management module with social listening capabilities. This allows an insurance provider or other organization to use the All-Insurance Platform to monitor social-media feeds of customers and other users, and respond with targeting offers, customer assistance, and other services. FIG. 3 illustrates how this social listening can be implemented by the All-Insurance Platform.

For example, as shown in FIG. 3, a first user 302 may have just purchased a home-insurance policy from an insurance carrier 304, and been satisfied with the experience. When first user 302 shares this good experience on social media as shown at 306, through Facebook or Twitter, for example, a social-media listening component of the All-Insurance Platform may be configured to detect the positive interaction with the insurance provider or positive mention of the insurance provider and automatically push a discount offer through the social-media channel to all of the followers of first user 302 on the social-media channel, as shown at 308.

For example, after the All-Insurance Platform detects the positive interaction, insurance provider 304 may send a message to first user 302 allowing that user to post a message to the social-media channel with an embedded link (a uniform resource locator, for example), as shown at 310. Alternatively, the All-Insurance Platform may be configured to send an advertisement with the embedded link to all of the followers of first user 302. The All-Insurance Platform may also be configured to send a notification to a customer representative 312 who may use the All-Insurance Platform to take appropriate action.

In one exemplary embodiment, when a second user 314, who follows first user 302 on the social-media channel, is interested in the discount pushed out by the All-Insurance Platform, as shown at 314, second user 314 follows the embedded link to a webpage 316 that provides second user 314 with a discount on insurance products if the user downloads and uses the mobile app associated with the All-Insurance Platform. As shown at 318, second user 314 downloads the mobile app, makes several online simulations 320 using the mobile app, and also requests a quote, as shown at 322.

The All-Insurance Platform may be configured such that quote request 322 triggers an alert 324 that is sent to an agent 326. The All-Insurance Platform may be configured with an automated agent or with a plurality of modules and functionality that can be used by a person to interact with customers and potential customers. As shown in FIG. 3 at 328, second user 314 is contacted by agent 326, and agent 326 is able to adjust the quote 330, interact with second user 314 to complete the subscription information 332, and generate a proposal 334 which is then sent to second user 314 through the mobile app.

Proposal 334 may include an option to sign up for a credit card or pre-paid card branded by the insurance provider that offers discounts on products and services purchased from the insurance provider as well as discounts on services and products purchased from third-party partners, as shown at 336. When second user 314 accepts this offer at 338, her eligibility for the offer is verified with the insurance provider and a card issuer at 340, and the All-Insurance Platform then activates the insurance-provider-branded card and sends activation instructions to second user 314, as shown at 342. Once she has accepted the terms and activated the card, second user 314 may then pay the premiums for her new policy using the card, as shown at 344. In one embodiment of the All-Insurance Platform, this is accomplished using a digital wallet within the mobile app, which may be configured to send payment confirmation 346 to agent 326, which permits the All-Insurance Platform to control completion and validation of the contract, as shown at 348.

FIG. 3 illustrates how an insurance provider using the All-Insurance Platform can acquire a new customer where all systems and interactions, from initial lead generation, customer contact, customer services, policy implementation, and integrated credit-card sign-up and payment can all be accomplished using the integrated system provided by the All-Insurance Platform.

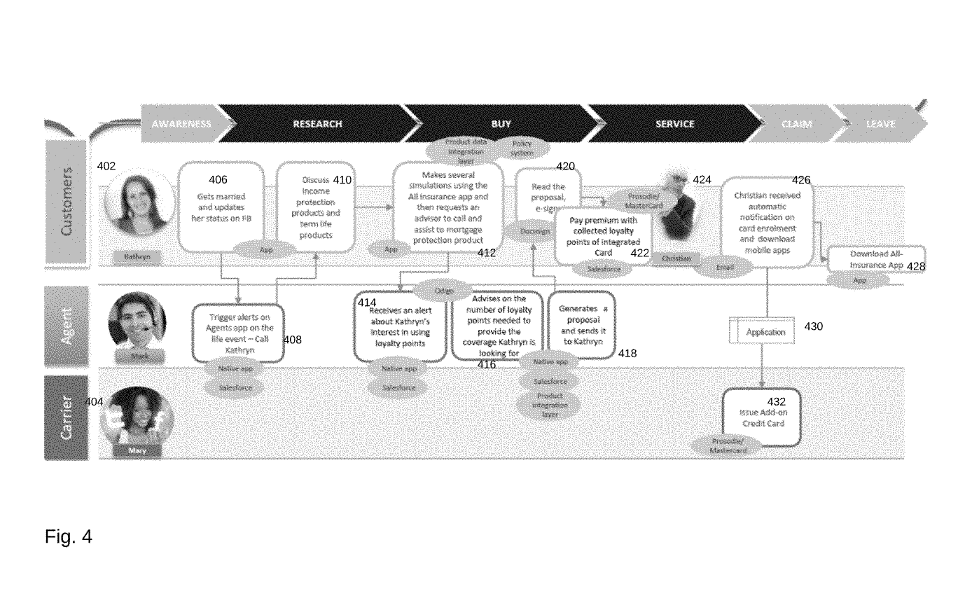

FIG. 4 illustrates an exemplary embodiment of how the All-Insurance Platform can be configured to assist a customer with payment for products and services using loyalty points as well as adding additional card holders to an account. In this example, a first user 402 is a customer of insurance provider 404 and is a loyal user of a credit card branded by the insurance provider. As shown at 406, first user 402 gets married and updates her status on social media. The social listening module of the All-Insurance Platform then triggers an alert 408 to an agent 410 informing the agent of the life event for first user 402. Agent 410 then contacts first user 402 to discuss income protection products, life insurance products, and other products that may be suitable for the new life situation of first user 402, as shown at 410.

In one exemplary embodiment of the All-Insurance Platform, the agent is able to contact first user 402 through a mobile application that forms part of the All-Insurance Platform. Using the mobile app, first user 402 is able to run several simulations and requests that an advisor call her and assist with a mortgage protection product, as shown at 412. This request may trigger an alert 414 that is sent to agent 410, who may then use the All-Insurance Platform to contact first user 402 and advise her on the number of loyalty points she has earned through use of her branded credit card, provide the insurance coverage the user is looking for, and inform her of how she can use her loyalty points toward payment of the insurance coverage product, as shown at 416.

As shown at 418, agent 410 may then generate a proposal that is sent to first user 402, who may then use the mobile app to read the proposal and e-sign the necessary documentation to put the insurance coverage into effect, as shown at 420. User 402 may then pay any premiums due for her new insurance coverage from insurance provider 404 using collected loyalty points earned from using her integrated credit card, as shown at 422.

Separately, the social listening module of the All-Insurance Platform may use the life-event trigger 408 to automatically send a notification to a second user 424, who is the new spouse of first user 402. As shown at 426, second user 424 may receive a notification, by email, text, or social-media, for example, notifying him that he is eligible to receive a credit card or other loyalty card from insurance provider 404. Notification 426 may also include a link so that second user 424 can download the mobile app forming a part of the All-Insurance Platform so that he can more easily interact with insurance provider 404. After downloading the mobile app, as shown at 428, he can then use the mobile app to send an application 430 to insurance provider 404. Through the All-Insurance Platform, insurance provider 404 can then approve the application and issue the insurance-provider-branded loyalty credit card, either as an add-on to the account of first user 402, or as a separate account.

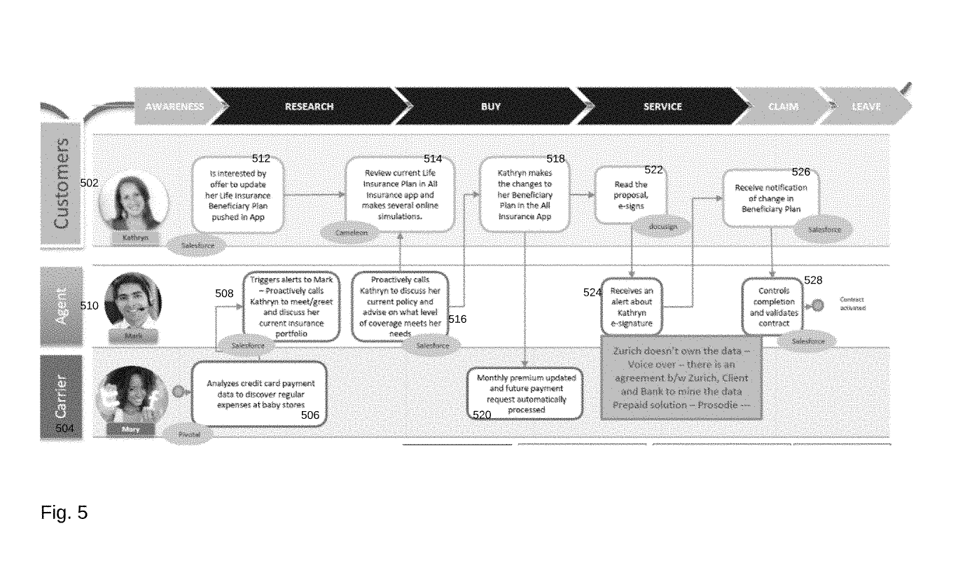

FIG. 5 illustrates an exemplary embodiment of how the All-Insurance Platform can be configured to assist in cross-selling and updating insurance policies for customers. In this example, a customer 502, who frequently uses an insurance-provider branded loyalty credit card, has recently had a child and is looking to update her life insurance beneficiary plan. In one embodiment, the insurance provider 504 uses the All-Insurance Platform to analyze credit card payment data of customer 502, as shown at 506, to discover regular expenses that relate to infant care. This discovery triggers an alert 508 that is sent to an agent 510 of the insurance provider. The alert notifies the agent of the potential life event that could signal a need for a change in insurance coverage for customer 502.

At the same time, customer 502 may receive an offer 512 within the mobile app that encourages her to update her life-insurance beneficiary plan. Customer 502 is then able to review her current life-insurance plan with the mobile app and run several online simulations, as shown at 514, to see how a change in coverage would affect her premiums and her policy. As shown at 516, agent 510 may also contact customer 502 to advise her as to the level of coverage that will meet her changed circumstances. Based on this input and the input from the simulations, customer 502 may then make a change to her beneficiary plan using the mobile app, as shown at 518. The changes she inputs in the mobile app are sent to insurance provider 504 through the All-Insurance Platform, which automatically updates her policy, including premium and payment information, as shown at 520.

In one exemplary embodiment, customer 502 receives updated policy information through the mobile app or through another application, and is able to read and e-sign the proposal, as shown at 522. This in turn triggers an alert sent to agent 510, notifying the agent that customer 502 has signed the new policy documents, as shown at 524. Customer 502 then receives notification, through the mobile app, by email, or by other suitable means, that the beneficiary plan has been changed, as shown at 526. The agent 510 then controls completion and validation of the contract, as shown at 528.

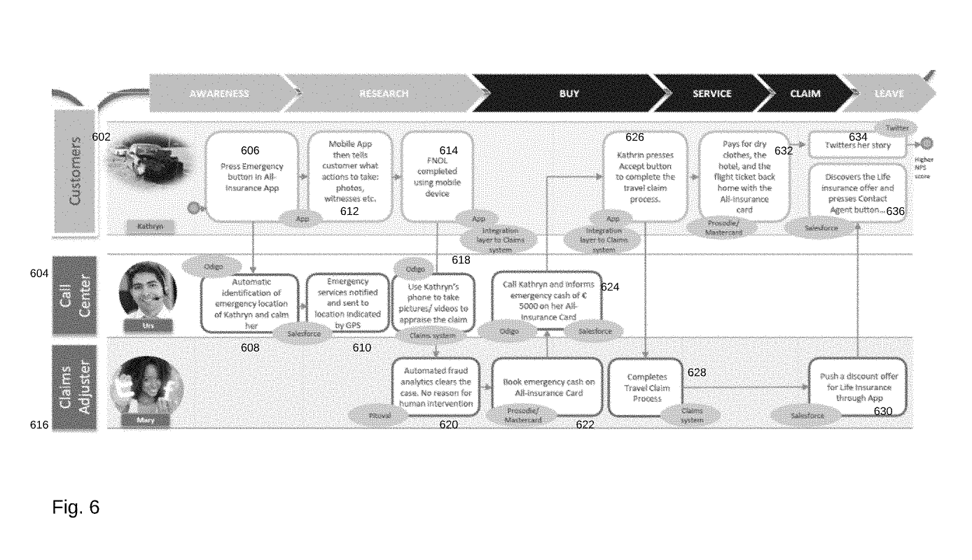

FIG. 6 illustrates an exemplary embodiment of how the All-Insurance Platform can be configured to execute efficient claims handling in emergency scenarios. In this example, a customer 602 is in a car accident. Her car is totaled in the accident, but she is able to use the mobile app that is part of the All-Insurance Platform to quickly contact an emergency call center 604, for example, by pressing and “emergency” button with the mobile app, as shown at 606. Through the All-Insurance Platform, call center 604 is able to automatically identify the customer's location, as shown at 608, and immediately notify emergency services and send customer 602, location to emergency services personnel, as shown at 610.

Once customer has activated the “emergency” feature within the mobile app, as shown at 612, the mobile app is configured to provide instructions to the customer as to what actions to take, including taking photos of the damages, gathering witnesses, etc. As shown at 614, customer 602 uses the camera in her mobile device to take pictures and uses the mobile app to complete a first-notice-of-loss (FNOL) process. The photos and other information entered by customer 602 is sent to call center 604 and forwarded on to a claims adjuster 616, as shown at 618. Through the All-Insurance Platform, claims adjuster 616 runs automated fraud analytics and other tests and determines that the claim can be approved without the need for human intervention, as shown at 620.

Using the All-Insurance Platform, claims adjuster 616 may then transfer emergency cash to the insurer-branded loyalty credit card or pre-paid card used by customer 602, as shown at 622. Call center 604 then sends notice to customer 602, through the mobile app, email, by phone, or other suitable means, that the emergency cash has been transferred to the customer's card, as shown at 624. Customer 602 may then be able to press a button within the mobile app to accept the money and complete the travel claim process, as shown at 626. Once this action is complete, claims adjuster 616 completes the travel claim process, as shown at 628, and may also push a discount offer for life insurance through the mobile app to customer 602, as shown at 630.

Customer 602 is able to pay for new clothes, a hotel, a flight home, or any other necessities using the insurance-provider-branded card, as shown at 632. She may also decide to share her positive experience on social media, as shown at 634, which further drives sales and customer retention and loyalty. After experiencing the accident and receiving the discount offer on life insurance, customer 602 may contact an agent at the insurance provider to discuss her options for life insurance, as shown at 636.

FIG. 7 illustrates an exemplary embodiment of how the All-Insurance Platform can be configured to identify opportunities for sales and assist in closing those sales. In this example, an agent 702 for insurance provider 704 accesses a user interface that includes an agent dashboard that shows, among other things, current activities for the day and progress against monthly targets, as shown at 706. As shown at 708, the insurance provider uses the All-Insurance Platform to analyze spending data of a customer 710, which it combines with social listening functionality to determine that customer 710 has recently had a baby. As shown at 712, the All-Insurance Platform may push an offer, through a mobile app provided by the insurance provider, for a life-insurance policy. The analytics performed by the All-Insurance Platform may also trigger an alert to agent 702, prompting the agent to contact customer 710 to discuss her insurance needs, as shown at 714.

Based on existing information on customer 710 gathered through the mobile app, social listening, and other sources, the All-Insurance Platform may be configured to automatically pre-populate a quote for customer 710. As shown at 718 and 720, agent 702 can then contact customer 702 to browse through several online simulations and discuss the customer's current policy and advice on what level of coverage will meet her needs, using a financial calculator, for example.

Once customer 710 has determined which life insurance policy will be best for her situation, she may use the mobile app to schedule a medical assessment, as shown at 722. In one exemplary embodiment, the medical results are uploaded directly to the insurance provider through the All-Insurance Platform, as shown at 724. Agent 702 can then automatically generate a proposal that is sent to customer 710, using both the pre-populated information and the results of the medical assessment, as shown at 726.

Customer 710 is able to read and e-sign the proposal within the mobile app, as shown in 728, and once this process is complete, the information is populated throughout the systems of the All-Insurance Platform and the monthly premiums and future payment requests are automatically processed, as shown in 730 and 732. Agent 702 is now able to view the updated information within the user-interface and also sees the progress toward his daily target on the dashboard, as shown at 734. Customer 710 is also able to view updated policy information from within the mobile app, as shown at 736.

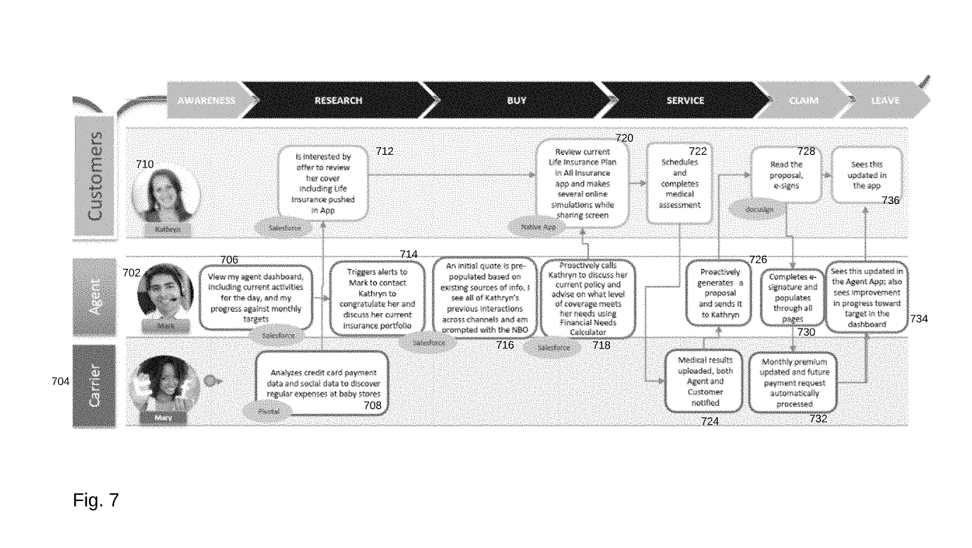

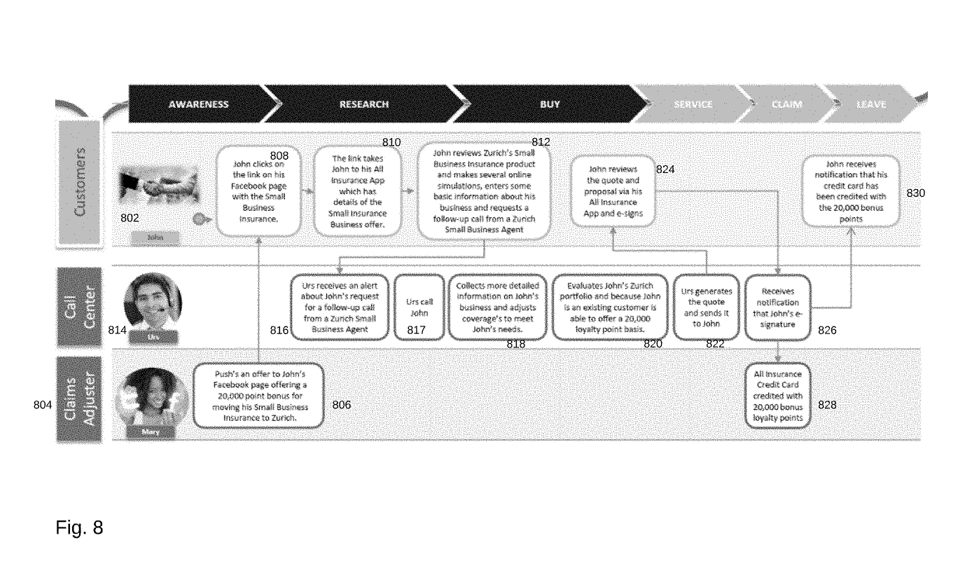

FIG. 8 illustrates an exemplary embodiment of how the All-Insurance Platform can be configured to assist in customer conversion and retention. In this example, customer 802 is a small-business owner and is looking to switch insurance carriers after a poor claims experience with his current small-business insurance carrier. Customer 802 is an existing customer for insurance provider 804, with personal insurance policies through this provider. Customer 802 also uses both the mobile app provided by insurance provider 804 and the insurance-provider-branded loyalty credit card.

Customer 802 posts about his negative experience with this small-business insurance provider on social media, and using the social listening functionality of the All-Insurance Platform, insurance provider 804 automatically detects the customer's dissatisfaction and pushes an offer to the customer through the same social-media channel offering customer 804 a predetermined number of bonus points on his loyalty card if he moves his small-business insurance policy to insurance provider 804, as shown at 806. The offer may include a link, which may take customer 802 to his mobile app, as shown at 808 and 810.

Within the mobile app, customer 802 may be able to review the small-business insurance policy options and run several online simulations, as shown at 812. He may be able to enter information about his business and request follow up from an agent. The request from customer 802 may then be sent to agent 814, who receives an alert 816 that notifies the agent that he should contact the customer. Agent 814 may then contact the customer, as shown at 817. Using the All-Insurance Platform, agent 814 may then collect more detailed information from customer 802 and adjust the insurance coverage to meet the customer's needs, as shown at 818. Agent 814 is also able to verify the status of customer 802 as a current customer of insurance provider 804, and is thus able to confirm eligibility for the offer to receive a predetermined number of loyalty points, as shown at 820.

Once the information has been entered into the systems of the All-Insurance Platform, a quote is automatically generated and sent to customer 802, as shown at 822. Customer 802 is able to review the quote and proposals through the mobile app, and is also able to e-sign the documentation, as shown at 824. Agent 814 receive notification 826 that the customer has e-signed the documents, and the All-Insurance Platform automatically credits the predetermined number of loyalty points directly to the loyalty credit card of customer 802, as shown at 828. As shown at 830, the All-Insurance Platform may also be configured to send an alert to customer 802 indicating that he has been credited with the predetermined number of loyalty points.

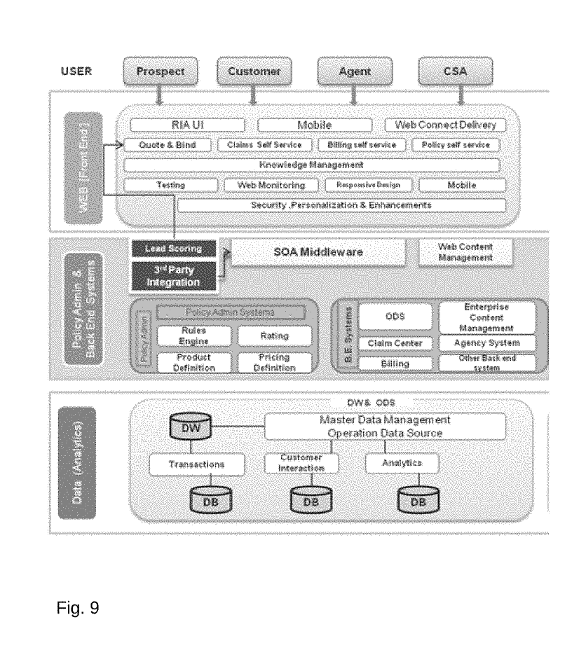

FIG. 9 illustrates an exemplary mobile integrated architecture framework that may be used in one embodiment of the All-Insurance Platform. As shown, the mobile integrated architecture framework integrates front-end, consumer-facing applications with policy-administration and back-end systems as well as various analytics engines and databases. The front-end systems may be used for end-to-end user experience management, web content delivery, web monitoring, and multivariate testing. The front-end systems may also support encryption and enterprise security standards to enable a unified single sign-in.

The back-end systems may include a middleware framework to enable consistent product, billing, payment, and claims customer experience across all channels. The back-end systems may also include enterprise web-content management for creating, managing, and syndicating content; operational data stores to abstract legacy policy systems to enhance customer experience and ensure quality data; and rules engines that provide functionality to model and change business logic, rules, and ratings to increase business agility.

The analytics systems and databases may include transaction data from customer relationship management software that can then be consolidated in data warehouses to enable effective product and pricing analytics. The analytics systems may also be configured to leverage master data management to create a comprehensive view of customer data, incorporating both transaction data and customer interaction data. The analytics systems may also include advance analytics support and ongoing web analytics and monitoring.

As enterprises take their journey from viewing to transaction to collaborating using mobile devices, various patterns can be identified and deconstructed into a set of capabilities required to meet the end-to-end mobile app lifecycle. The All-Insurance Platform is able to meet the needs of these enterprises. For example there are three stages in the mobile-app lifecycle: developing/deploying a mobile app, running/hosting a mobile solution, and supporting mobile-app end users. In one embodiment, the All-Insurance Platform can be configured to execute all three of these stages when used by an insurance provider or other organization.

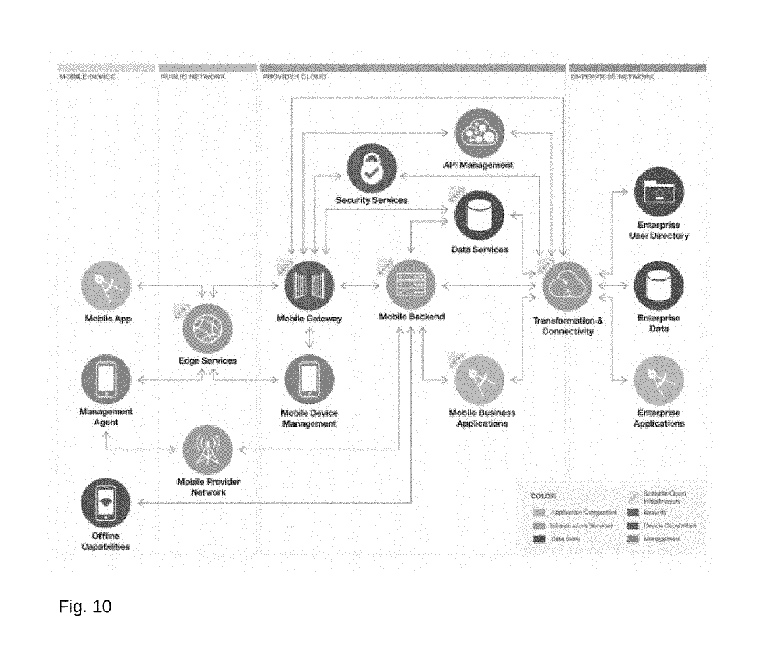

As shown in FIG. 10, in one exemplary embodiment, the All-Insurance Platform has a four-tiered architecture: a mobile device tier, a public network tier, the provider cloud tier, and the enterprise network tier. The mobile device tier is the point of contact for users; the public network tier connects the devices to mobile cloud services; the provider cloud tier is where the various cloud services exist; and the enterprise network tier contains a plurality of enterprise applications, services, and data.

In one exemplary embodiment, the All-Insurance Platform includes a plurality of mobile applications or apps for use by customers as well as agents and other users within an insurance provider. These apps form a part of the mobile device tier illustrated in FIG. 10. For example, the All-Insurance Platform may include a mobile app for use by customers.

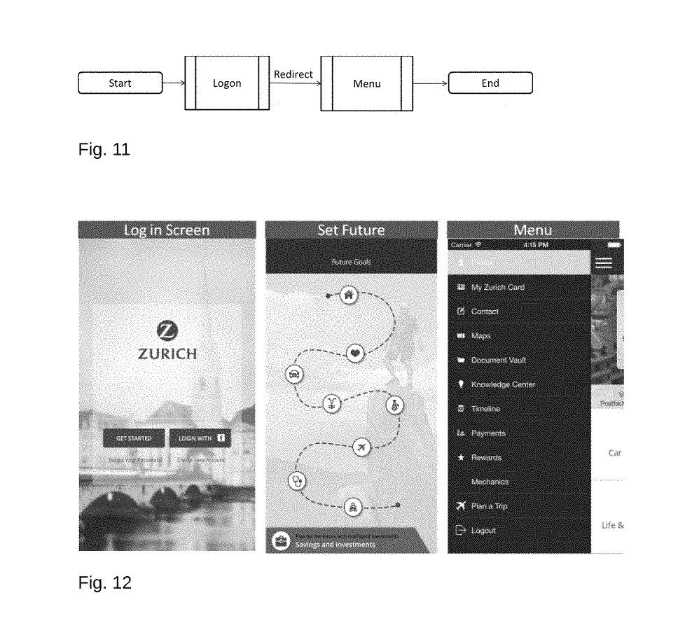

FIGS. 11 through 40 illustrates examples of the functionality of the mobile app and information flows between the app and other systems in one embodiment of the All-Insurance Platform.

FIG. 11 shows a use case for a login procedure for the mobile app, and FIG. 12 shows exemplary screenshots of what a user might encounter when logging in to the mobile app. As shown, the mobile app may be protected with a login password or other security, and may direct a user that has logged in to an initial menu of options for interacting with mobile app, including use of a pre-paid or credit card branded by the insurance provider, as well as functionality for accessing contacts at the insurance provider, accessing maps, a document vault, a knowledge center, a timeline, a payments center, a rewards center, repair functionality, and trip planning functionality.

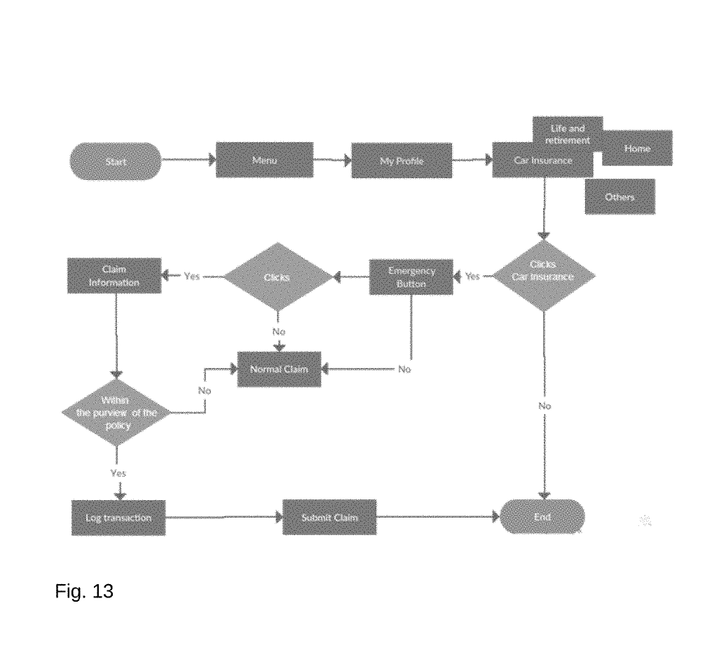

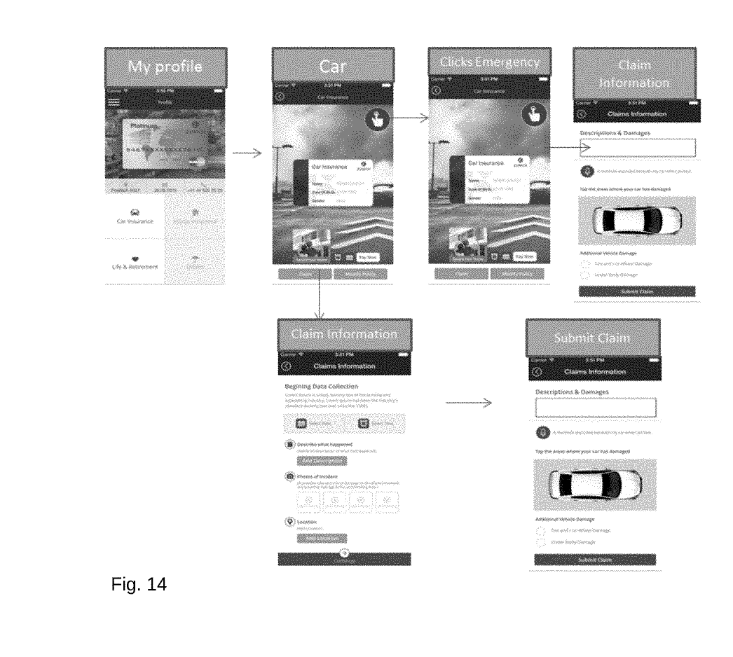

FIG. 13 illustrates a use case showing how a user might navigate through the menu in the mobile app to access a car insurance section of the app and submit a claim in real time using an “emergency” button. FIG. 14 illustrates exemplary screenshots and functionality corresponding to the use case shown in FIG. 13. As shown in FIG. 14, the mobile app may include functionality that allows the user to enter claim information, take pictures, describe the damage done to the car, and submit a claim, all within the mobile app.

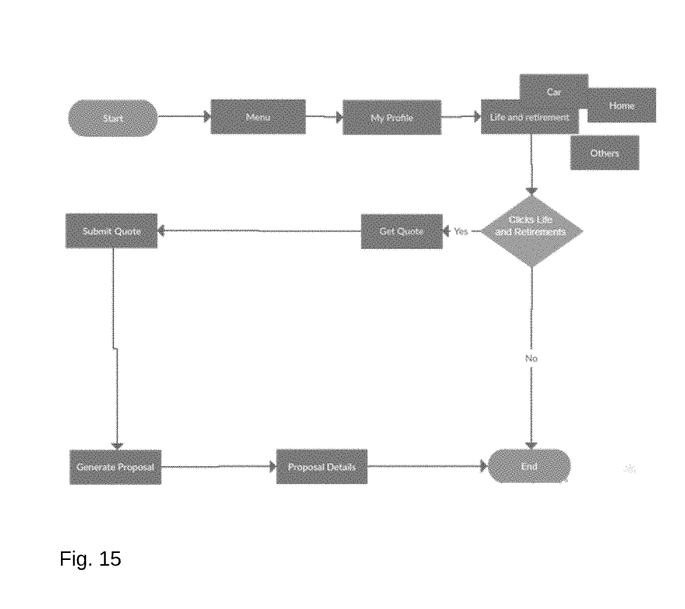

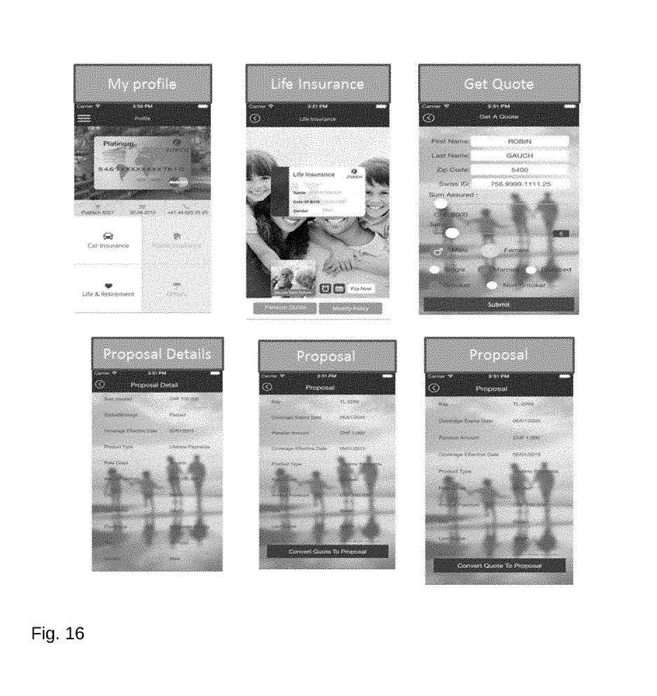

FIG. 15 illustrates a use case showing how a user might navigate through the menu of the mobile app to access life insurance products, run simulations, and get a quote and an insurance proposal using the mobile app. FIG. 16 illustrates exemplary screenshots and functionality corresponding to the use case shown in FIG. 15.

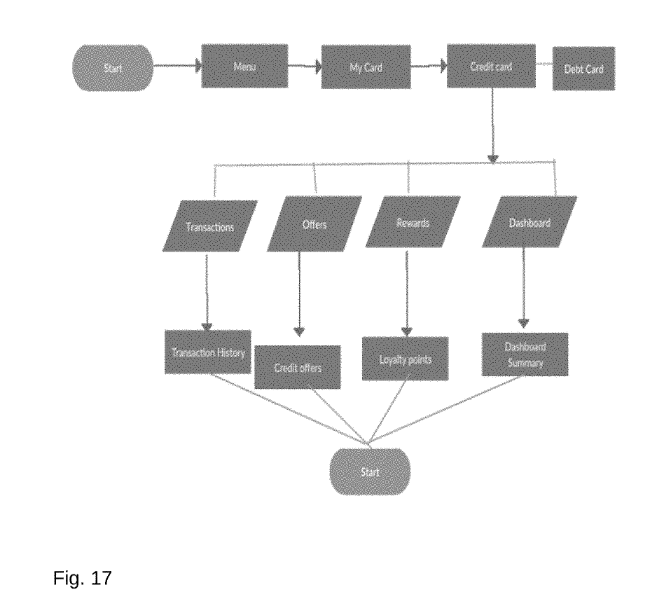

FIG. 17 illustrates a use case for the insurance-provider-branded loyalty card functionality that may be integrated into the mobile app. Through a “my card” functionality on the menu, the user may be able to access a credit card, a debit card, or a pre-paid card affiliated with the insurance provider. The mobile app may include functionality for viewing transactions, offers, rewards, and a dashboard that summarizes and displays card activity, balances, and other useful information.

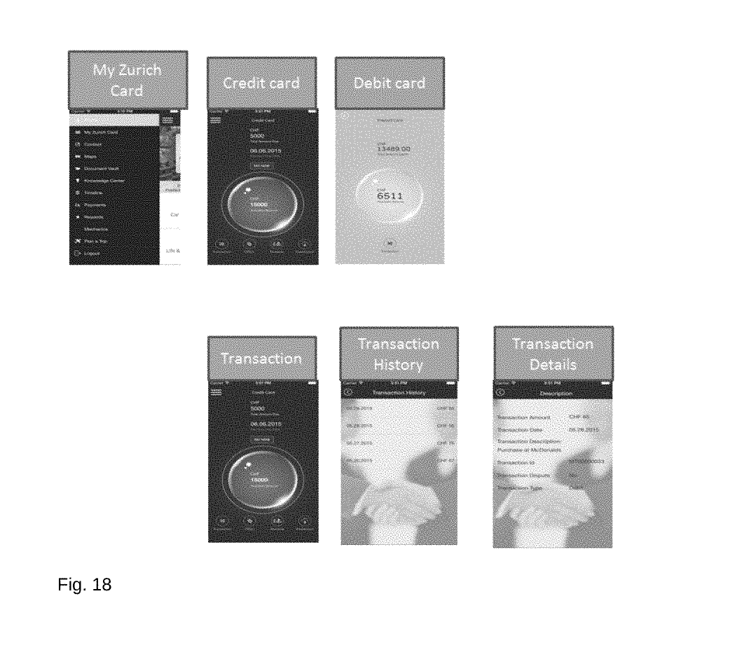

FIG. 18 illustrates exemplary screenshots showing the transaction functionality, which may include access to transaction details and transaction history for an insurance-provider-branded card. Advantageously, the mobile app may also include functionality that allows the user of the mobile app to pay for products and services from the insurance provider and from other third-party retail partners from within the mobile app.

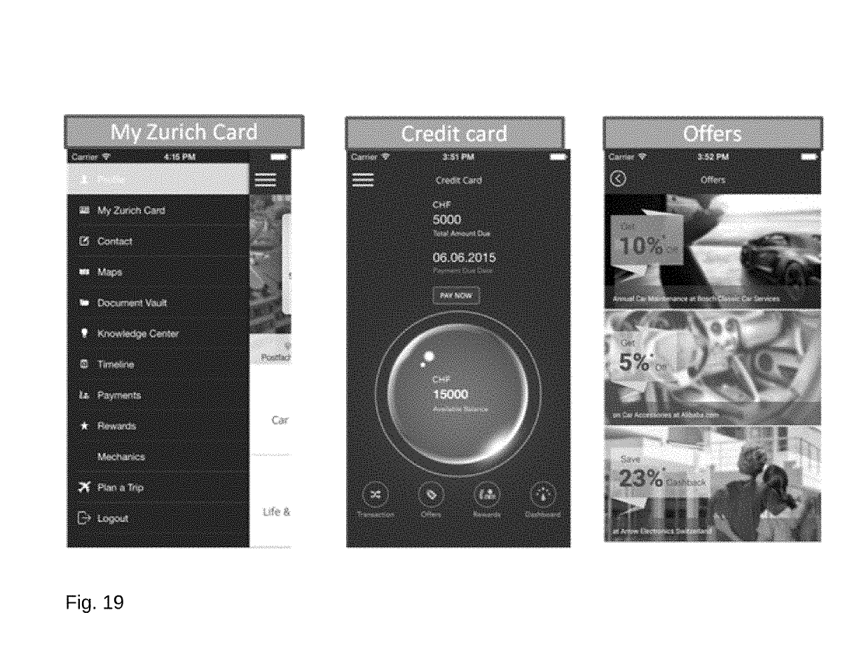

FIG. 19 illustrates exemplary screenshots showing the offers functionality of the “my card” section of the mobile app, which can include various discount offers from both the insurance provider and retail partners. In one exemplary embodiment, the user can apply the offer to his or her account by simply selecting one of the offers displayed.

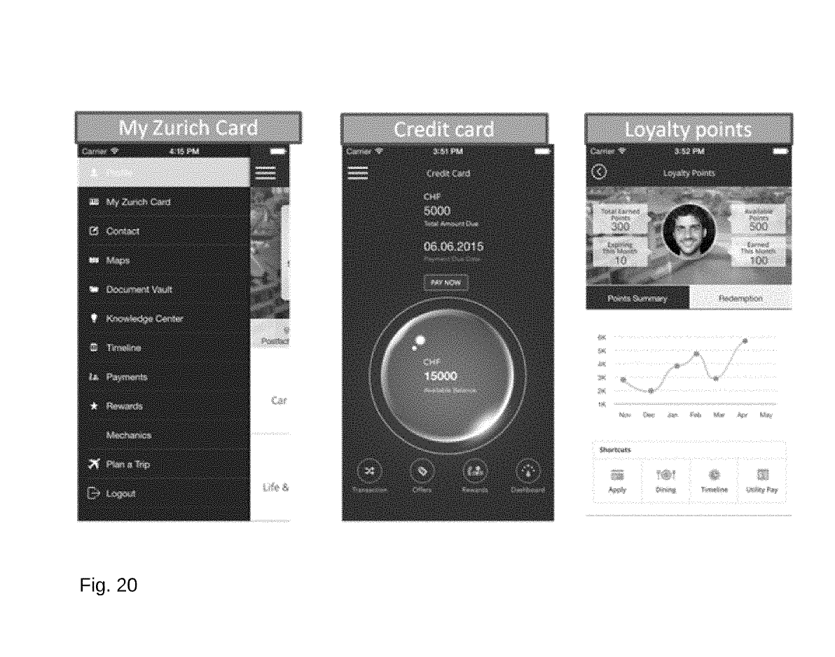

FIG. 20 illustrates exemplary screenshots showing the rewards functionality of the “my card” section of the mobile app, which may include a display showing the user how many loyalty points have been earned and redeemed. The mobile app may also include functionality for redeeming loyalty points from within the app itself.

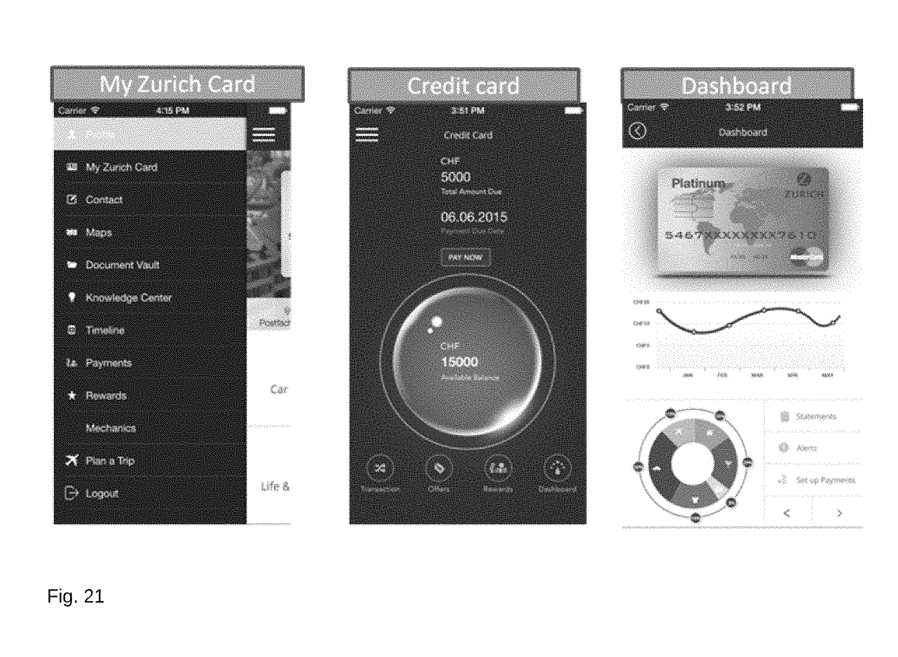

FIG. 21 illustrates exemplary screenshots showing the dashboard functionality of the “my card” section of the mobile app, which may include a summary of spending and balances, and access to statements, alerts, and payments as well as a summary of loyalty points earned and redeemed.

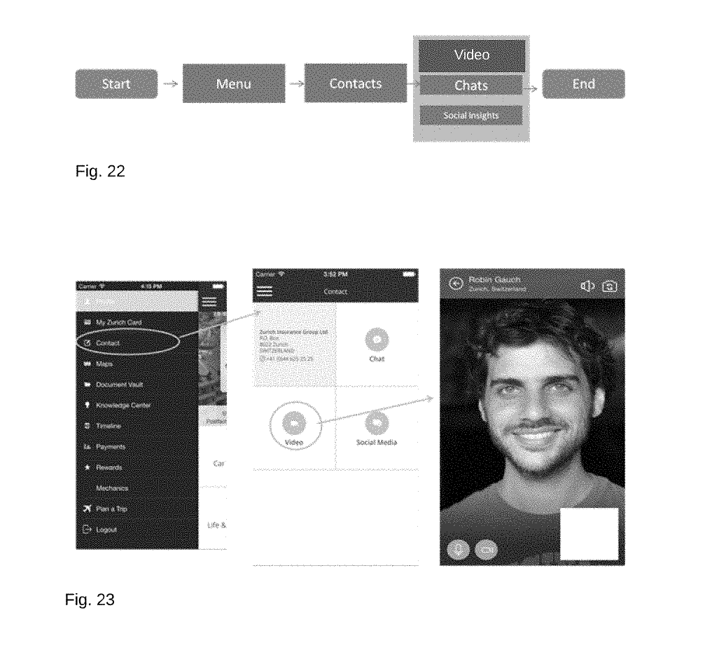

FIG. 22 is illustrates an exemplary use case where a user of the mobile app is accessing a contact function from the menu, and FIG. 23 illustrates exemplary screenshots that the user might encounter when accessing the contacts function. As shown in these figures, the user may be able to contact the insurance provider by phone, by video chat, by text message or chat, by social media, all without leaving the mobile app.

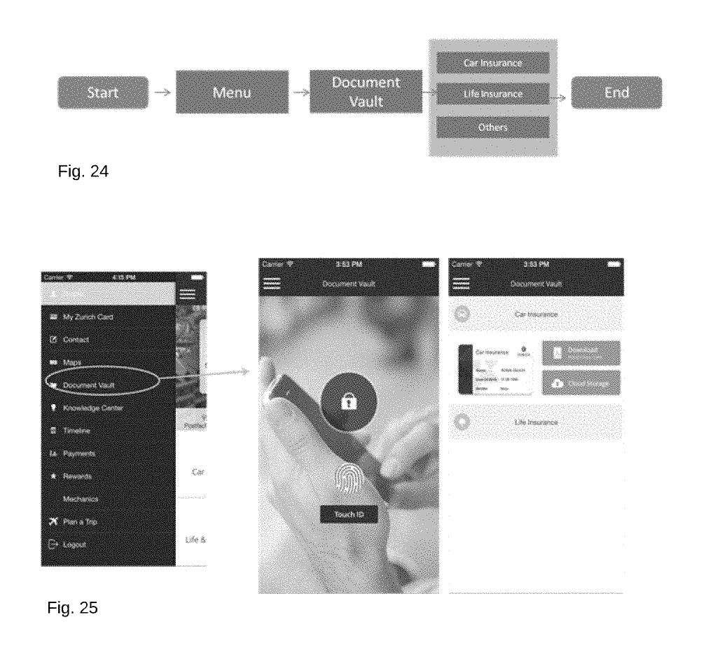

FIG. 24 illustrates an exemplary use case where a user of the mobile app is accessing a document vault function in the mobile app. FIG. 25 illustrates exemplary screenshots that the user might encounter when accessing the document vault. As shown, the document vault may be secured by additional security measures such as an additional password, two-factor authentication, or biometrics. The document vault may be used to store important documents and information, including car insurance policies, life insurance policies, beneficiary details, and insurance cards. In one exemplary embodiment, the document vault may be configured to store other documents of a user's choosing that may be unrelated to the insurance provider.

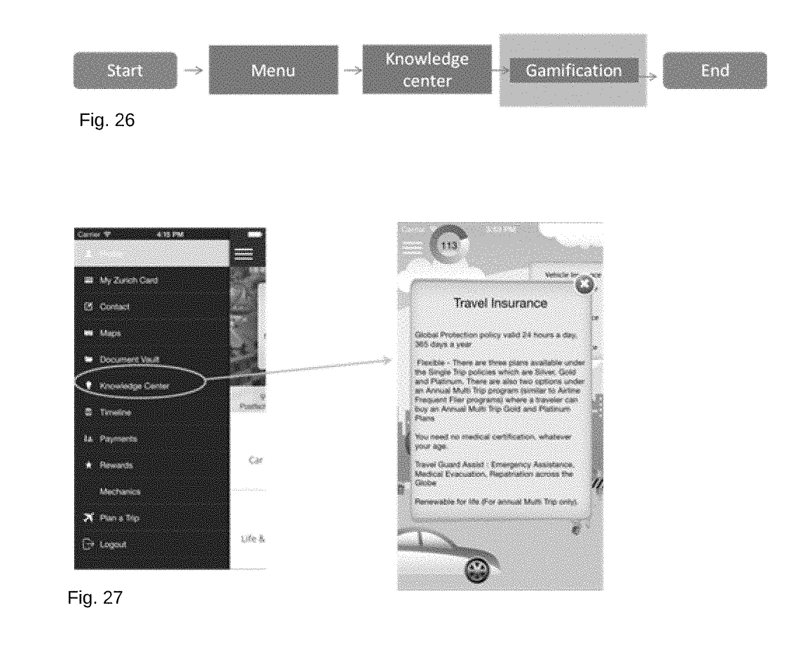

FIG. 26 illustrates an exemplary use case where a user is able to access the knowledge center within the mobile app, and FIG. 27 illustrates exemplary screenshots that the user may encounter when accessing the knowledge center. In one embodiment, the knowledge center includes search functionality that allows users to quickly educate themselves on myriad topics relating to the insurance provider and its products. The knowledge center may also include a link that allows a user to quickly contact a customer service representative if the user is unable to find the answer he or she is looking for.

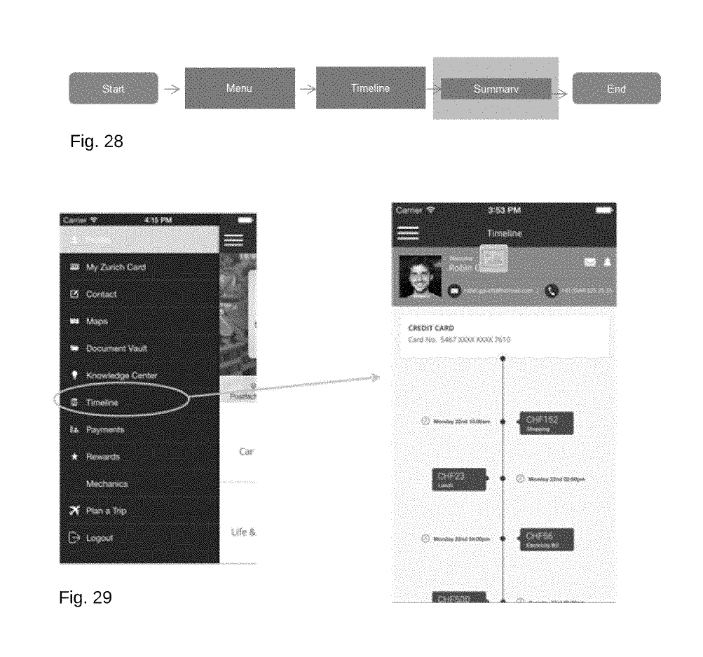

FIG. 28 illustrates an exemplary use case where a user accesses the timeline functionality from the menu of the mobile app, and FIG. 29 illustrates exemplary screenshots of the timeline functionality. As shown the timeline may be tied the user's credit card and show a timeline of spending with an indication of what each expense was for.

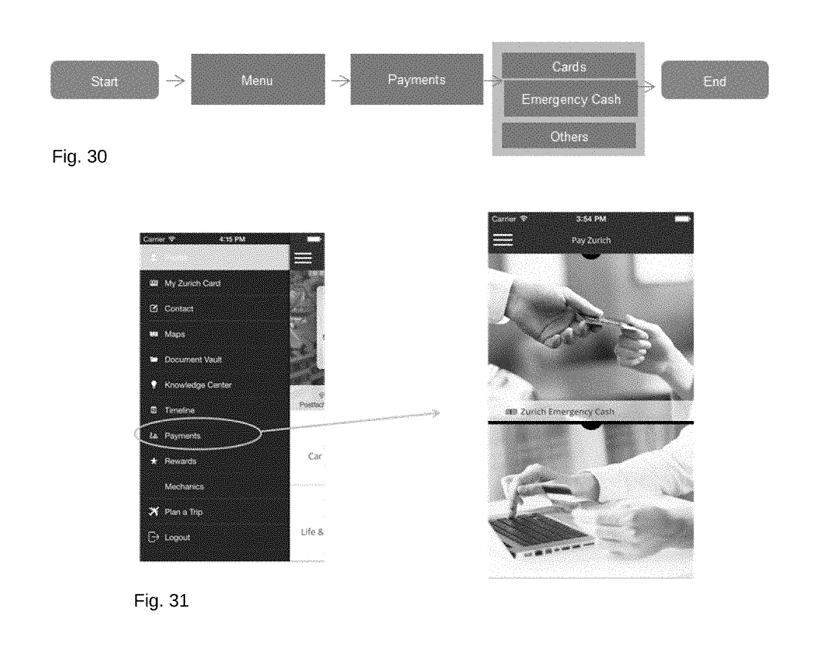

FIG. 30 illustrates an exemplary use case where a user accesses the payments functionality of the mobile app, and FIG. 31 illustrates exemplary screenshots of that might be encountered by a user when accessing the payments functionality. As shown, a user may be able to access insurance-provider-branded loyalty cards (credit cards, debit cards, and pre-paid cards), as well as access emergency cash from the insurance provider.

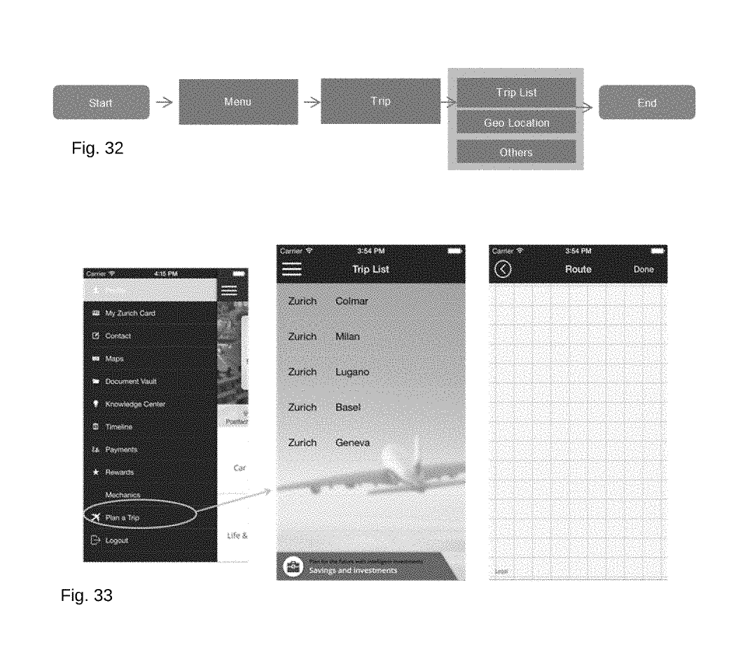

FIG. 32 illustrates an exemplary use case where a user accesses the “plan a trip” functionality within the mobile app, and FIG. 33 shows exemplary screenshots for this functionality.

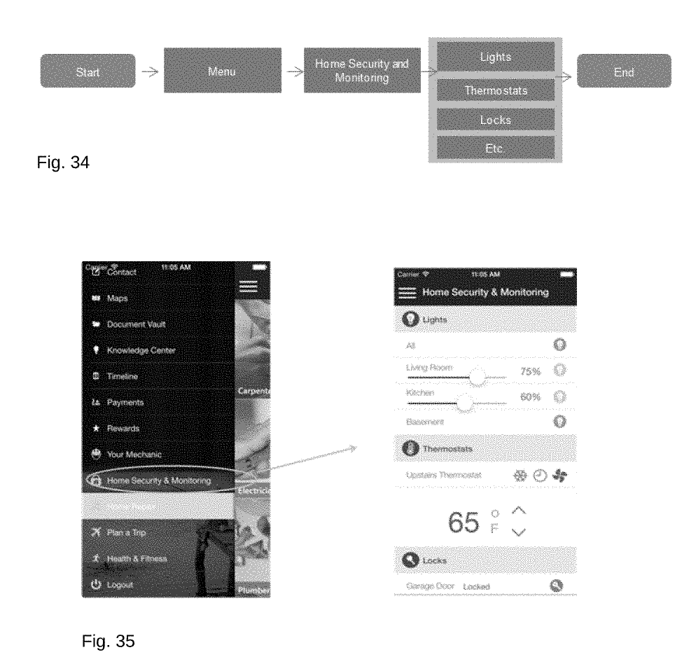

FIG. 34 illustrates an exemplary use case where a user accesses “home security and monitoring” functionality with the mobile app, and FIG. 35 illustrates exemplary screenshots of this functionality. As shown, a user may be able to use the mobile app to control the lights, thermostat, locks, and other smart devices in their home remotely.

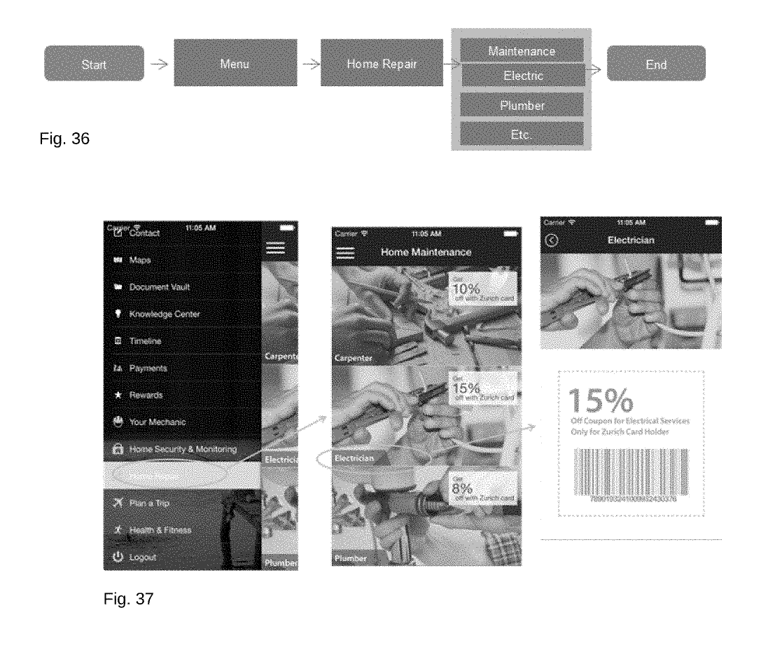

FIG. 36 illustrates an exemplary use case where a user accesses “home repair” functionality with the mobile app, and FIG. 37 illustrates exemplary screenshots of this functionality. In one embodiment, the “home repair” functionality in the mobile app provides discounts on home repair products and services when the user purchases these products or services using the integrated insurance-provider-branded loyalty card.

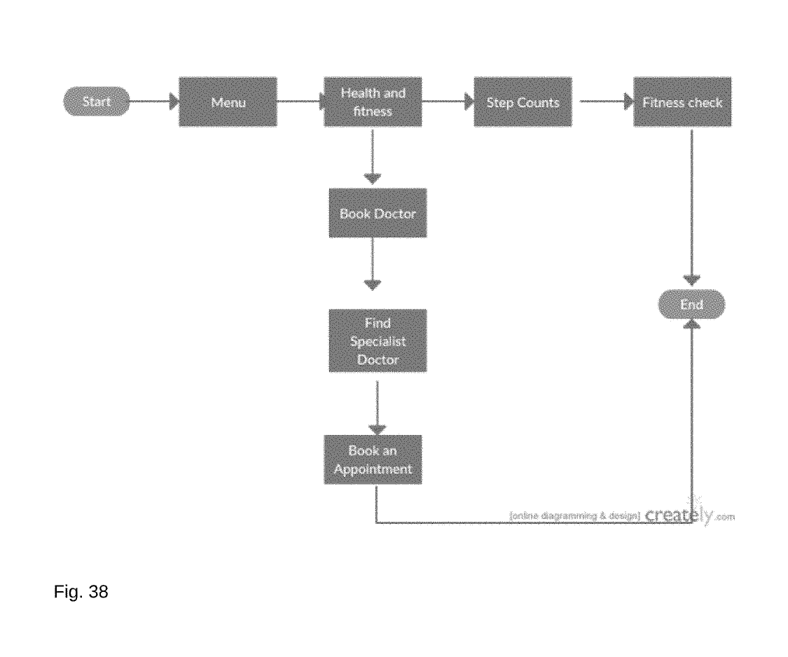

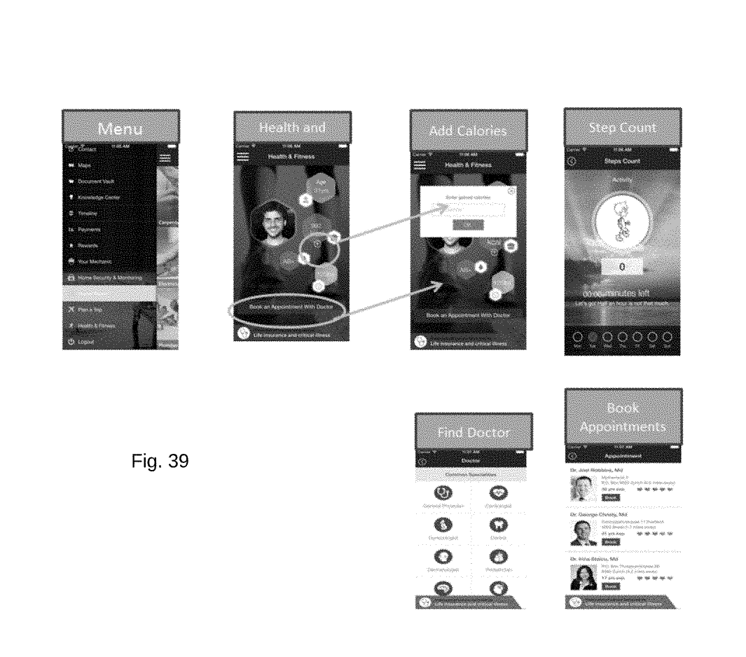

FIG. 38 illustrates an exemplary use case where a user accesses a “health and fitness” functionality from within the mobile app, and FIG. 39 exemplary screenshots of this functionality. As shown in FIGS. 38 and 39, the user may be able to access a pedometer function from with the mobile app, take a fitness assessment, search for a doctor or other specialist, and book an appointment with the doctor or other specialist.

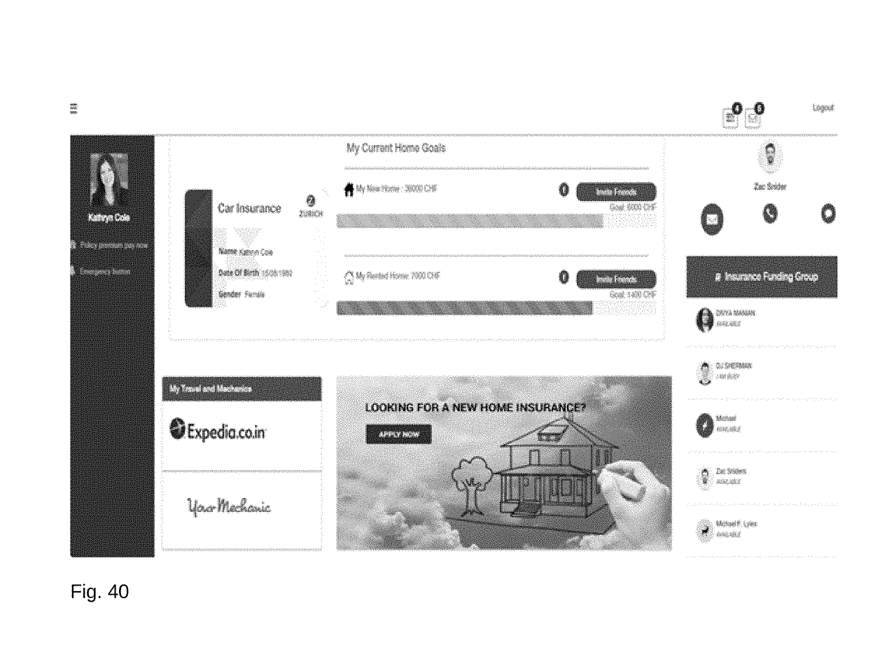

In one embodiment, the mobile app may include a dashboard, as shown in FIG. 40, which may be accessible through a mobile device, a desktop, a laptop, or any other suitable computing device and which provides a summary of insurance policies, spending on loyalty cards, discounts from third-party providers, and other pertinent information. The dashboard can be configured and personalized by the user and may be configured to parse and interpret data in many different ways depending on the user's preference.

The All-Insurance Platform may also generate alerts and timely reports to ensure adherence to regulatory deadlines and may be configured to help insurance providers and other users regularly monitor suspicious transactions and identify high-risk customers, products, and service geographies. The All-Insurance Platform may also include smart user interfaces and tools that allow customers to tailor their own solutions and that provide customers with customized solutions based on identified customer preferences and behavior.

The user may also be able to earn points on savings accounts, current accounts, debit cards, and credit cards by using the mobile app. The points that are earned can then be spent on rewards spread across various categories. As explained above, the All-Insurance Platform, including the mobile app, includes wide-ranging and customizable functionality that encourages customer loyalty and retention.

### All-Insurance Platform Controller

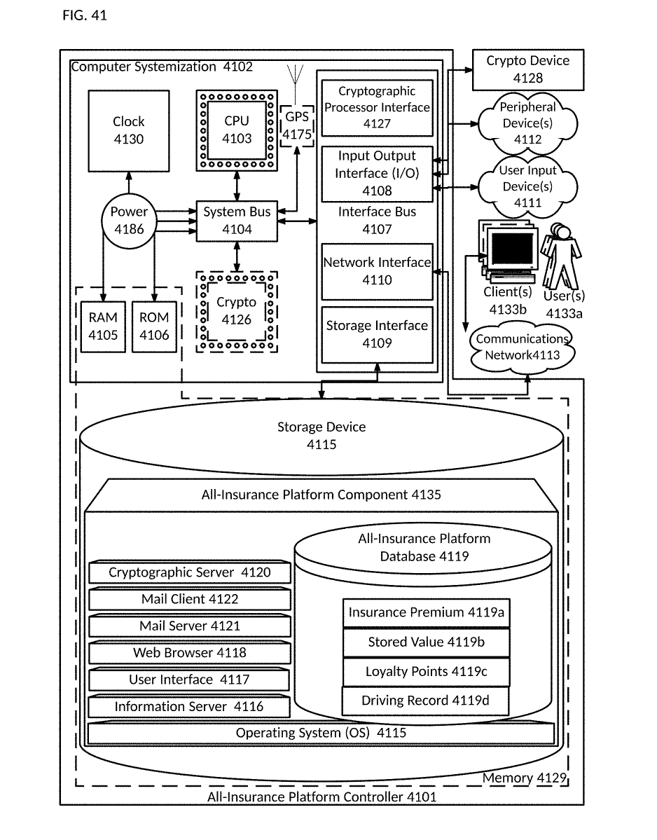

FIG. 41 illustrates inventive aspects of an All-Insurance Platform controller 4101 in a block diagram. In this embodiment, the All-Insurance Platform controller 4101 may serve to aggregate, process, store, search, serve, identify, instruct, generate, match, and/or facilitate interactions with a computer through enterprise technologies, and/or other related data.

Typically, users, which may be people and/or other systems, may engage information technology systems (e.g., computers) to facilitate information processing. In turn, computers employ processors to process information; such processors 4103 may be referred to as central processing units (CPU). One form of processor is referred to as a microprocessor. CPUs use communicative circuits to pass binary encoded signals acting as instructions to enable various operations. These instructions may be operational and/or data instructions containing and/or referencing other instructions and data in various processor accessible and operable areas of memory 4129 (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the All-Insurance Platform controller 4101 may be connected to and/or communicate with entities such as, but not limited to: one or more users from user input devices 4111; peripheral devices 4112; an optional cryptographic processor device 4128; and/or a communications network 4113.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The All-Insurance Platform controller 4101 may be based on computer systems that may comprise, but are not limited to, components such as: a computer systemization 4102 connected to memory 4129.

### Computer Systemization

A computer systemization 4102 may comprise a clock 4130, central processing unit (“CPU(s)” and/or “processor(s)” (these terms are used interchangeable throughout the disclosure unless noted to the contrary)) 4103, a memory 4129 (e.g., a read only memory (ROM) 4106, a random access memory (RAM) 4105, etc.), and/or an interface bus 4107, and most frequently, although not necessarily, are all interconnected and/or communicating through a system bus 4104 on one or more (mother)board(s) 4102 having conductive and/or otherwise transportive circuit pathways through which instructions (e.g., binary encoded signals) may travel to effect communications, operations, storage, etc. Optionally, the computer systemization may be connected to an internal power source 4186. Optionally, a cryptographic processor 4126 may be connected to the system bus. The system clock typically has a crystal oscillator and generates a base signal through the computer systemization's circuit pathways. The clock is typically coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be commonly referred to as communications. These communicative instructions may further be transmitted, received, and the cause of return and/or reply communications beyond the instant computer systemization to: communications networks, input devices, other computer systemizations, peripheral devices, and/or the like. Of course, any of the above components may be connected directly to one another, connected to the CPU, and/or organized in numerous variations employed as exemplified by various computer systems.

The CPU comprises at least one high-speed data processor adequate to execute program components for executing user and/or system-generated requests. Often, the processors themselves will incorporate various specialized processing units, such as, but not limited to: integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory 529 beyond the processor itself; internal memory may include, but is not limited to: fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state. The CPU may be a microprocessor such as: AMD's Athlon, Duron and/or Opteron; ARM's application, embedded and secure processors; IBM and/or Motorola's DragonBall and PowerPC; IBM's and Sony's Cell processor; Intel's Celeron, Core (2) Duo, Itanium, Pentium, Xeon, and/or XScale; and/or the like processor(s). The CPU interacts with memory through instruction passing through conductive and/or transportive conduits (e.g., (printed) electronic and/or optic circuits) to execute stored instructions (i.e., program code) according to conventional data processing techniques. Such instruction passing facilitates communication within the All-Insurance Platform controller and beyond through various interfaces. Should processing requirements dictate a greater amount speed and/or capacity, distributed processors (e.g., Distributed All-Insurance Platform), mainframe, multi-core, parallel, and/or super-computer architectures may similarly be employed. Alternatively, should deployment requirements dictate greater portability, smaller Personal Digital Assistants (PDAs) may be employed.

Depending on the particular implementation, features of the All-Insurance Platform may be achieved by implementing a microcontroller such as CAST's R8051XC2 microcontroller; Intel's MCS 51 (i.e., 8051 microcontroller); and/or the like. Also, to implement certain features of the All-Insurance Platform, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the All-Insurance Platform component collection (distributed or otherwise) and/or features may be implemented via the microprocessor and/or via embedded components; e.g., via ASIC, coprocessor, DSP, FPGA, and/or the like. Alternately, some implementations of the All-Insurance Platform may be implemented with embedded components that are configured and used to achieve a variety of features or signal processing.

Depending on the particular implementation, the embedded components may include software solutions, hardware solutions, and/or some combination of both hardware/software solutions. For example, All-Insurance Platform features discussed herein may be achieved through implementing FPGAs, which are a semiconductor devices containing programmable logic components called “logic blocks,” and programmable interconnects, such as the high performance FPGA Virtex series and/or the low cost Spartan series manufactured by Xilinx. Logic blocks and interconnects can be programmed by the customer or designer, after the FPGA is manufactured, to implement any of the All-Insurance Platform features. A hierarchy of programmable interconnects allow logic blocks to be interconnected as needed by the All-Insurance Platform system designer/administrator, somewhat like a one-chip programmable breadboard. An FPGA's logic blocks can be programmed to perform the function of basic logic gates such as AND, and XOR, or more complex combinational functions such as decoders or simple mathematical functions. In most FPGAs, the logic blocks also include memory elements, which may be simple flip-flops or more complete blocks of memory. In some circumstances, the All-Insurance Platform may be developed on regular FPGAs and then migrated into a fixed version that more resembles ASIC implementations. Alternate or coordinating implementations may migrate All-Insurance Platform controller features to a final ASIC instead of or in addition to FPGAs. Depending on the implementation all of the aforementioned embedded components and microprocessors may be considered the “CPU” and/or “processor” for the All-Insurance Platform.

### Power Source

The power source 4186 may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 4186 is connected to at least one of the interconnected subsequent components of the All-Insurance Platform thereby providing an electric current to all subsequent components. In one example, the power source 4186 is connected to the system bus component 4104. In an alternative embodiment, an outside power source 4186 is provided through a connection across the I/O 4108 interface. For example, a USB and/or IEEE 1394 connection carries both data and power across the connection and is therefore a suitable source of power.

### Interface Adapters

Interface bus(ses) 4107 may accept, connect, and/or communicate to a number of interface adapters, conventionally although not necessarily in the form of adapter cards, such as but not limited to: input output interfaces (I/O) 4108, storage interfaces 4109, network interfaces 4110, and/or the like. Optionally, cryptographic processor interfaces 4127 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 4109 may accept, communicate, and/or connect to a number of storage devices such as, but not limited to: storage devices 4114, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 4110 may accept, communicate, and/or connect to a communications network 4113. Through a communications network 4113, the All-Insurance Platform controller is accessible through remote clients 4133b (e.g., computers with web browsers) by users 4133a. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. Should processing requirements dictate a greater amount speed and/or capacity, distributed network controllers (e.g., Distributed All-Insurance Platform), architectures may similarly be employed to pool, load balance, and/or otherwise increase the communicative bandwidth required by the All-Insurance Platform controller. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 4110 may be used to engage with various communications network types 4113. For example, multiple network interfaces may be employed to allow for the communication over broadcast, multicast, and/or unicast networks.

Input Output interfaces (I/O) 4108 may accept, communicate, and/or connect to user input devices 4111, peripheral devices 4112, cryptographic processor devices 4128, and/or the like. I/O may employ connection protocols such as, but not limited to: audio: analog, digital, monaural, RCA, stereo, and/or the like; data: Apple Desktop Bus (ADB), IEEE 1394a-b, serial, universal serial bus (USB); infrared; joystick; keyboard; midi; optical; PC AT; PS/2; parallel; radio; video interface: Apple Desktop Connector (ADC), BNC, coaxial, component, composite, digital, Digital Visual Interface (DVI), high-definition multimedia interface (HDMI), RCA, RF antennae, S-Video, VGA, and/or the like; wireless: 802.11a/b/g/n/x, Bluetooth, code division multiple access (CDMA), global system for mobile communications (GSM), WiMax, etc.; and/or the like. One typical output device may include a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Another output device is a television set, which accepts signals from a video interface. Typically, the video interface provides the composited video information through a video connection interface that accepts a video display interface (e.g., an RCA composite video connector accepting an RCA composite video cable; a DVI connector accepting a DVI display cable, etc.).

User input devices 4111 may be card readers, dongles, finger print readers, gloves, graphics tablets, joysticks, keyboards, mouse (mice), remote controls, retina readers, trackballs, trackpads, touchpads, and/or the like.

Peripheral devices 4112 may be connected and/or communicate to I/O and/or other facilities of the like such as network interfaces, storage interfaces, and/or the like. Peripheral devices may be audio devices, cameras, dongles (e.g., for copy protection, ensuring secure transactions with a digital signature, and/or the like), external processors (for added functionality), goggles, microphones, monitors, network interfaces, printers, scanners, storage devices, video devices, video sources, visors, and/or the like.

It should be noted that although user input devices and peripheral devices may be employed, the All-Insurance Platform controller may be embodied as an embedded, dedicated, and/or monitor-less (i.e., headless) device, wherein access would be provided over a network interface connection.

Cryptographic units such as, but not limited to, microcontrollers, processors 4126, interfaces 4127, and/or devices 4128 may be attached, and/or communicate with the All-Insurance Platform controller. A MC68HC16 microcontroller, manufactured by Motorola Inc., may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of CPU. Equivalent microcontrollers and/or processors may also be used. Other commercially available specialized cryptographic processors include: the Broadcom's CryptoNetX and other Security Processors; nCipher's nShield, SafeNet's Luna PCI (e.g., 7100) series; Semaphore Communications' 40 MHz Roadrunner 184; Sun's Cryptographic Accelerators (e.g., Accelerator 6000 PCIe Board, Accelerator 500 Daughtercard); Via Nano Processor (e.g., L2100, L2200, U2400) line, which is capable of performing 500+MB/s of cryptographic instructions; VLSI Technology's 33 MHz 6868; and/or the like.

### Memory

Generally, any mechanization and/or embodiment allowing a processor to affect the storage and/or retrieval of information is regarded as memory 4129. However, memory is a fungible technology and resource, thus, any number of memory embodiments may be employed in lieu of or in concert with one another. It is to be understood that the All-Insurance Platform controller and/or a computer systemization may employ various forms of memory 4129. For example, a computer systemization may be configured wherein the functionality of on-chip CPU memory (e.g., registers), RAM, ROM, and any other storage devices are provided by a paper punch tape or paper punch card mechanism; of course such an embodiment would result in an extremely slow rate of operation. In a typical configuration, memory 4129 will include ROM 4106, RAM 4105, and a storage device 4114. A storage device 4114 may be any conventional computer system storage. Storage devices may include a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); an array of devices (e.g., Redundant Array of Independent Disks (RAID)); solid state memory devices (USB memory, solid state drives (SSD), etc.); other processor-readable storage mediums; and/or other devices of the like. Thus, a computer systemization generally requires and makes use of memory.

### Component Collection

The memory 4129 may contain a collection of program and/or database components and/or data such as, but not limited to: operating system component(s) 4115 (operating system); information server component(s) 4116 (information server); user interface component(s) 4117 (user interface); Web browser component(s) 4118 (Web browser); database(s) 4119; mail server component(s) 4121; mail client component(s) 4122; cryptographic server component(s) 4120 (cryptographic server); the All-Insurance Platform component(s) 4135; and/or the like (i.e., collectively a component collection). These components may be stored and accessed from the storage devices and/or from storage devices accessible through an interface bus. Although non-conventional program components such as those in the component collection, typically, are stored in a local storage device 4114, they may also be loaded and/or stored in memory such as: peripheral devices, RAM, remote storage facilities through a communications network, ROM, various forms of memory, and/or the like.

### Operating System

The operating system component 4115 is an executable program component facilitating the operation of the All-Insurance Platform controller. Typically, the operating system facilitates access of I/O, network interfaces, peripheral devices, storage devices, and/or the like. The operating system may be a highly fault tolerant, scalable, and secure system such as: Apple Macintosh OS X (Server); AT&T Plan 9; Be OS; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millenium/NT/Vista/XP (Server)/7/8, Palm OS, and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the All-Insurance Platform controller to communicate with other entities through a communications network 4113. Various communication protocols may be used by the All-Insurance Platform controller as a subcarrier transport mechanism for interaction, such as, but not limited to: multicast, TCP/IP, UDP, unicast, and/or the like.

### Information Server

An information server component 4116 is a stored program component that is executed by a CPU. The information server may be a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective-) C (++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the All-Insurance Platform controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the All-Insurance Platform database 4119, operating systems, other program components, user interfaces, Web browsers, and/or the like.

Access to the All-Insurance Platform database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the All-Insurance Platform. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the All-Insurance Platform as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

### User Interface

The function of computer interfaces in some respects is similar to automobile operation interfaces. Automobile operation interface elements such as steering wheels, gearshifts, and speedometers facilitate the access, operation, and display of automobile resources, functionality, and status. Computer interaction interface elements such as check boxes, cursors, menus, scrollers, and windows (collectively and commonly referred to as widgets) similarly facilitate the access, operation, and display of data and computer hardware and operating system resources, functionality, and status. Operation interfaces are commonly called user interfaces. Graphical user interfaces (GUIs) such as the Apple Macintosh Operating System's Aqua, IBM's OS/2, Microsoft's Windows 2000/2003/3.1/95/98/CE/Millenium/NT/XP/Vista/7 (i.e., Aero)/8, Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery(UI), MooTools, Prototype, script.aculo.us, SWFObject, Yahoo! User Interface, any of which may be used and) provide a baseline and means of accessing and displaying information graphically to users.

A user interface component 4117 is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

### Web Browser

A Web browser component 4118 is a stored program component that is executed by a CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., FireFox, Safari Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Of course, in place of a Web browser and information server, a combined application may be developed to perform similar functions of both. The combined application would similarly affect the obtaining and the provision of information to users, user agents, and/or the like from the All-Insurance Platform enabled nodes. The combined application may be nugatory on systems employing standard Web browsers.

### Mail Server

A mail server component 4121 is a stored program component that is executed by a CPU 4103. The mail server may be a conventional Internet mail server such as, but not limited to sendmail, Microsoft Exchange, and/or the like. The mail server may allow for the execution of program components through facilities such as ASP, ActiveX, (ANSI) (Objective-) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the All-Insurance Platform.

Access to the All-Insurance Platform mail may be achieved through a number of APIs offered by the individual Web server components and/or the operating system.

Also, a mail server may contain, communicate, generate, obtain, and/or provide program component, system, user, and/or data communications, requests, information, and/or responses.

### Mail Client

A mail client component 4122 is a stored program component that is executed by a CPU 4103. The mail client may be a conventional mail viewing application such as Apple Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

### Cryptographic Server

A cryptographic server component 4120 is a stored program component that is executed by a CPU 4103, cryptographic processor 4126, cryptographic processor interface 4127, cryptographic processor device 4128, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash function), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the All-Insurance Platform may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audio file. A cryptographic component may communicate to and/or with other components in a component collection, including itself, and/or facilities of the like. The cryptographic component supports encryption schemes allowing for the secure transmission of information across a communications network to enable the All-Insurance Platform component to engage in secure transactions if so desired. The cryptographic component facilitates the secure accessing of resources on the All-Insurance Platform and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

### The all-Insurance Platform Database

The All-Insurance Platform database component 4119 may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the All-Insurance Platform database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of functionality encapsulated within a given object. If the All-Insurance Platform database is implemented as a data-structure, the use of the All-Insurance Platform database 4119 may be integrated into another component such as the All-Insurance Platform component 4135. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component 4119 includes several tables, such as insurance premium table 4119a, stored value table 4119b, loyalty points table 4119c, and driving record table 4119d. In one embodiment, the All-Insurance Platform database may interact with other database systems. For example, employing a distributed database system, queries and data access by search All-Insurance Platform component may treat the combination of the All-Insurance Platform database, an integrated data security layer database as a single database entity.

In one embodiment, user programs may contain various user interface primitives, which may serve to update the All-Insurance Platform. Also, various accounts may require custom database tables depending upon the environments and the types of clients the All-Insurance Platform may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components 4119a-d. The All-Insurance Platform may be configured to keep track of various settings, inputs, and parameters via database controllers.

The All-Insurance Platform database may communicate to and/or with other components in a component collection, including itself, and/or facilities of the like. Most frequently, the All-Insurance Platform database communicates with the All-Insurance Platform component, other program components, and/or the like. The database may contain, retain, and provide information regarding other nodes and data.

### The All-Insurance Platforms

The All-Insurance Platform component 4135 is a stored program component that is executed by a CPU. In one embodiment, the All-Insurance Platform component incorporates any and/or all combinations of the aspects of the All-Insurance Platform that was discussed in the previous figures. As such, the All-Insurance Platform affects accessing, obtaining and the provision of information, services, transactions, and/or the like across various communications networks.

The All-Insurance Platform component enabling access of information between nodes may be developed by employing standard development tools and languages such as, but not limited to: Apache components, Assembly, ActiveX, binary executables, (ANSI) (Objective-) C (++), C# and/or .NET, database adapters, CGI scripts, Java, JavaScript, mapping tools, procedural and object oriented development tools, PERL, PHP, Python, shell scripts, SQL commands, web application server extensions, web development environments and libraries (e.g., Microsoft's ActiveX; Adobe AIR, FLEX & FLASH; AJAX; (D)HTML; Dojo, Java; JavaScript; jQuery(UI); MooTools; Prototype; script.aculo.us; Simple Object Access Protocol (SOAP); SWFObject; Yahoo! User Interface; and/or the like), WebObjects, and/or the like. In one embodiment, the All-Insurance Platform server employs a cryptographic server to encrypt and decrypt communications. The All-Insurance Platform component may communicate to and/or with other components in a component collection, including itself, and/or facilities of the like. Most frequently, the All-Insurance Platform component communicates with the All-Insurance Platform database, operating systems, other program components, and/or the like. The All-Insurance Platform may contain, communicate, generate, obtain, and/or provide program component, system, user, and/or data communications, requests, and/or responses.

### Distributed All-Insurance Platforms

The structure and/or operation of any of the All-Insurance Platform node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion.

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through standard data processing communication techniques.

The configuration of the All-Insurance Platform controller will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If component collection components are discrete, separate, and/or external to one another, then communicating, obtaining, and/or providing data with and/or to other component components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), local and remote application program interfaces Jini, Remote Method Invocation (RMI), SOAP, process pipes, shared files, and/or the like. Messages sent between discrete component components for inter-application communication or within memory spaces of a singular component for intra-application communication may be facilitated through the creation and parsing of a grammar. A grammar may be developed by using standard development tools such as lex, yacc, XML, and/or the like, which allow for grammar generation and parsing functionality, which in turn may form the basis of communication messages within and between components. For example, a grammar may be arranged to recognize the tokens of an HTTP post command, e.g.:
w3c-post http:// . . . Value1

where Value1 is discerned as being a parameter because “http://” is part of the grammar syntax, and what follows is considered part of the post value. Similarly, with such a grammar, a variable “Value1” may be inserted into an “http://” post command and then sent. The grammar syntax itself may be presented as structured data that is interpreted and/or otherwise used to generate the parsing mechanism (e.g., a syntax description text file as processed by lex, yacc, etc.). Also, once the parsing mechanism is generated and/or instantiated, it itself may process and/or parse structured data such as, but not limited to: character (e.g., tab) delineated text, HTML, structured text streams, XML, and/or the like structured data. In another embodiment, inter-application data processing protocols themselves may have integrated and/or readily available parsers (e.g., the SOAP parser) that may be employed to parse (e.g., communications) data. Further, the parsing grammar may be used beyond message parsing, but may also be used to parse: databases, data collections, data stores, structured data, and/or the like. Again, the desired configuration will depend upon the context, environment, and requirements of system deployment.

To address various issues related to, and improve upon, previous work, the application is directed to INTEGRATED PAYMENT, INSURANCE, AND LOYALTY PLATFORM APPARATUSES, METHODS, AND SYSTEMS. The entirety of this application shows by way of illustration various embodiments. The advantages and features disclosed are representative; they are not exhaustive or exclusive. They are presented only to assist in understanding and teaching the claimed principles. It should be understood that they are not representative of all claimed inventions. As such, certain aspects of the invention have not been discussed herein. That alternate embodiments may not have been presented for a specific portion of the invention or that further undescribed alternate embodiments may be available for a portion of the invention is not a disclaimer of those alternate embodiments. It will be appreciated that many of those undescribed embodiments incorporate the same principles of the invention and others are equivalent. Thus, it is to be understood that other embodiments may be utilized and functional, logical, organizational, structural and/or topological modifications may be made without departing from the scope and/or spirit of the invention. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the invention, and inapplicable to others. In addition, the disclosure includes other inventions not presently claimed. Applicant reserves all rights in those presently unclaimed inventions including the right to claim such inventions, file additional applications, continuations, continuations in part, divisions, and/or the like thereof. As such, it should be understood that advantages, embodiments, examples, functionality, features, logical aspects, organizational aspects, structural aspects, topological aspects, and other aspects of the disclosure are not to be considered limitations on the disclosure as defined by the claims or limitations on equivalents to the claims.

The invention claimed is:

1. A system for integrating payment, insurance, and loyalty program services into a single platform, the system comprising:
a plurality of processors interfacing with a plurality of memory units;
a channels module configured to run on one or more processors and to interface with a plurality of customer devices through a network;
an interaction management module configured to run on the one or more processors and interface with the channels module to provide insurance products and services from an insurance provider to customers using the plurality of customer devices;
a consumer management module configured to run on the processor and interface with the channels module and interaction management module, wherein the consumer management module includes a loyalty card functionality configured to store value for a customer and apply that value to interactions with the insurance provider through an application running on the customer device.

2. The system of claim 1, wherein the customer devices include at least one of mobile devices, on-vehicle devices, kiosks, wearable devices, point-of-sale devices, tablets, smartphones, desktops, smart television devices, and gaming consoles.

3. The system of claim 1, wherein the interaction management module includes a social listening module configured to monitor social-media feeds of customers using the customer devices.

4. The system of claim 3, wherein the social listening module is further configured to detect a positive interaction between a first customer and the insurance provider, and automatically initiate an action when the positive interaction is detected.

5. The system of claim 4, wherein the action includes sending discount offers to one or more additional users connected to the first customer.

6. The system of claim 4, wherein the action includes sending an offer to the first customer.

7. The system of claim 1, further comprising an analytics engine interfacing with the interaction management module and being configured to analyze loyalty card payment data to determine patterns.

8. The system of claim 1, wherein the loyalty card functionality is configured to allow each customer to use a loyalty card to pay for insurance premiums and other products from within the application running on the consumer device.

9. The system of claim 1, wherein the loyalty card functionality is configured to allow the consumer to apply loyalty points to pay for insurance premiums and other products from within the application.

10. The system of claim 1, wherein the loyalty card functionality is configured to function as a credit card.

11. The system of claim 1, wherein the loyalty card functionality is configured to function as a debit card.

12. The system of claim 1, wherein the loyalty card functionality is configured to function as a prepaid stored-value card.

13. The system of claim 1, wherein the application running on the customer device is provided by the insurance provider.

14. The system of claim 1, wherein the application running on the customer device includes functionality for receiving emergency cash using the loyalty card.

15. The system of claim 1, wherein the application running on the customer device includes functionality for submitting a claim to the insurance provider.

16. The system of claim 1, wherein the application running on the customer device includes functionality for viewing and signing policy documents from the insurance provider.

17. The system of claim 1, wherein the application running on the customer device includes functionality for using the loyalty card to purchase goods as services from third-party merchants.

18. The system of claim 1, wherein the application running on the customer device includes functionality for insurance, loyalty card use, contacts, a document vault, a knowledge center, home security, home repair, health and fitness, and travel planning.

19. The system of claim 1, wherein the interaction management module further comprises a sales and distribution module, a marketing module, and a customer service module.

20. The system of claim 1, further comprising an integration management module interfacing with the consumer management module.
